(19) United States
(12) Patent Application Publication
(10) Pub. No.: US 2007/0216595 A1
(43) Pub. Date: Sep. 20, 2007

(54) Dielectric-Loaded Antenna

(75) Inventors: Shinji Hashiyama, Kyoto (JP); Tetsuo Shinkai, Kyoto (JP); Yuzo Okano, Kyoto (JP); Takehiko Kobayashi, Tokyo (JP)

Correspondence Address: OSHA LIANG L.L.P., 1221 MCKINNEY STREET, SUITE 2800, HOUSTON, TX, 77010, US

(73) Assignees: OMRON Corporation, Kyoto (JP); Tokyo Denki University, Tokyo (JP)

(21) Appl. No.: 10/569,399

(22) PCT Filed: Aug. 25, 2004
(86) PCT No.: PCT/JP04/12187

§ 371 Date: Nov. 10, 2006

(30) Foreign Application Priority Data
Aug. 25, 2003 (JP) 2003-208706

(51) Int. Cl. H01Q 1/48

(52) U.S. Cl. 343/848

(57) ABSTRACT

A mono-conical antenna serving as a dielectric-loaded antenna includes: (i) a electricity supply electrode, which has a conical surface; (ii) an earth electrode, which has a flat surface that is so positioned as to face an apex of the conical surface; and (iii) a dielectric member, which is provided between the conical surface and the flat surface. The dielectric member has an outer circumferential surface which has such a slope that extends from a side of the conical surface to a side of the flat surface. This allows the dielectric-loaded antenna to have a small size, and to handle a wider frequency band in which the maximum value of the VSWR is restrained to be small.

### TECHNICAL FIELD

The present invention relates to a dielectric-loaded antenna, and particularly to a dielectric-loaded antenna having a small size and handling a wide band.

### BACKGROUND ART

In recent years, a mobile information processing apparatus having a wireless communication function has been greatly pervasive. Frequently adopted as the wireless communication carried out by such a mobile information processing apparatus is wireless communication employing wireless LAN etc., using an electromagnetic wave having a frequency falling within, e.g., the 2.4 GHz band (2.471 GHz to 2.4.97 GHz).

Proposed on the other hand is the UWB (Ultra Wide Band) communication using a frequency band much wider than that of the conventional wireless LAN communication. The UWB communication is also referred to as “impulse communication” (impulse radio). In the UMB communication, data is exchanged by transmitting and receiving an electromagnetic wave having a pulse whose width is very short. Such transmission and reception of the electromagnetic wave having the pulse whose amplitude is very short makes it possible that the UWB communication uses a frequency band of a several GHz order, such as a ultra wide band ranging from approximately 3.1 GHz to approximately 10.6 GHz. Accordingly, the use of the UWB communication makes it possible that: communication is carried out even in the presence of an obstacle such as a wall, and phasing is very small, and time resolution is high, and a processing gain is very high. These are greatly advantageous over the conventional wireless LAN communication.

Important for realization of such a UWB communication in the mobile information processing apparatus is development of a small ultra wideband antenna.

Conventionally known as an antenna handling a wide frequency band is a conical antenna such as a bi-conical antenna or a mono-conical antenna (discone antenna). The bi-conical antenna is formed by two electrodes which respectively have circular cone shapes and which are so provided that the respective apexes of the electrodes meet each other and that the electrodes are symmetrical to each other. On the other hand, the mono-conical antenna is made up of (i) a circular cone shaped electrode (cone), and (ii) a circular plate shaped electrode which is provided in the vicinity of the apex of the circular cone shaped electrode such that the center of the apex corresponds to and is perpendicular to the center line of the circular cone shaped electrode.

However, a conical antenna handling the aforementioned ultra wide band has such a problem that the size of the conical antenna is large. For example, see a case of realizing a mono-conical antenna handling the ultra wide band ranging from approximately 3.1 GHz to approximately 10.6 GHz. In this case, the circular cone electrode has a diameter of approximately 20 cm to approximately 30 cm. Such a large conical antenna cannot be installed in the mobile information processing apparatus.

Here, disclosed in Japanese Unexamined Patent Publication Tokukaihei 08-139515/1996 (published on May 31, 1996; hereinafter, referred to as “Patent document 1”) is a small and short dielectric vertically polarized wave antenna suitable for the conventional wireless LAN communication or the like.

FIG. 27 is a perspective view illustrating the dielectric vertically polarized wave antenna, and FIG. 28 is a cross sectional view illustrating the dielectric vertically polarized wave antenna. The dielectric vertically polarized wave antenna is arranged as follows. That is, a radiation electrode 111 is formed in a portion formed by digging, in the form of a cone, one bottom surface of a cylindrical dielectric member 110. On the other hand, an earth electrode 112 is formed on the other bottom surface of dielectric member 110. The radiation electrode 111 is led out to the earth electrode 112 via a conductive pin 114 positioned in a through hole.

Patent document 1 further discloses that: the cylindrical dielectric member 110 constituting the dielectric vertically polarized wave antenna has a diameter of 9.6 mm, and has a height of 10 mm so as to attain communication using a frequency band whose central frequency is 2.599 GHz and whose bandwidth is 112.4 MHz.

Examples of publicly known documents about an antenna including such a dielectric member include: (i) Patent document 1, (ii) Japanese Unexamined Utility Model Publication Jitsukaihei 05-57911/1993 (published on Jul. 30, 1993), (iii) Japanese PCT National Phase Unexamined Patent Publication Tokukaihyo 10-501384/1998 (published on Feb. 3, 1998), (iv) Japanese Unexamined Patent Publication Tokukaihei 6-112730/1994 (published on Apr. 22, 1994), and (v) Japanese Patent Number 3201736 (issued on Aug. 27, 2001).

Further, a publicly known document about analysis on electromagnetic wave radiation in the bi-conical antenna including the dielectric member is, e.g., ROBERT E. STOVALL, KENNETH K. Mei “Application of a Unimoment Technique to a Biconical Antenna with Inhomogeneous Dielectric Loading” IEEE TRANSACTIONS ON ANTENNAS, VOL. AP-23, No. 3, MAY 1975, p.p. 335-342.

The dielectric vertically polarized wave antenna disclosed in Patent document 1 has a bandwidth of 100 MHz order, and can be therefore applied to the conventional wireless LAN. However, such a dielectric vertically polarized wave antenna having the bandwidth of 100 MHz order cannot be applied to the UWB communication using the ultra wide band of several GHz order.

Here, a property defining a frequency band usable in an antenna is VSWR (Voltage Standing Wave Ratio). A general definition of the VSWR is: “A ratio of (i) the maximum amplitude to (ii) the minimum amplitude of a field (voltage or current) which is in a steady state and which is generated, in response to application of a wave to uniform transmission lines or uniform wave guide tubes, along a transmission line or a wave guide tube each oriented in the propagation direction. VSWR=(1+ p)/(1−p), where ‘p’ indicates reflection coefficient”.

It is preferable that the VSWR of the antenna be low in an entire frequency band of signals sent and received by using the antenna. In general, it is preferable that the maximum value of the VSWR be restrained so as to be approximately 2 to approximately 3. Reasons of this are as follows.

The first reason is that: increase of the VSWR causes increase of a percentage of energy to be reflected, in energy applied to the antenna. This causes decrease of a percentage of energy to be actually irradiated into the air. In other words, an antenna having a large VSWR loses much energy, and has poor radiation efficiency.

The second reason is that: when the maximum value of the VSWR is large, difference becomes large between (i) the maximum value of the VSWR in a predetermined frequency band and (ii) the minimum value thereof. Specifically, when the maximum value of the VSWR is large, the VSWR is fluctuated greatly in response to a frequency change. When the VSWR is fluctuated greatly in response to the frequency change as such, a waveform of the signal to be sent or received is changed. For example, consider a case where the antenna sends or receives a pulse wave signal having a frequency spectrum distributed in a predetermined frequency band. When the VSWR of the antenna is fluctuated greatly in the frequency band, the frequency spectrum of the signal sent to the antenna and the frequency spectrum of the signal sent therefrom are not in conformity with each other, with the result that the waveform of the output signal becomes different from the waveform of the input signal.

Note that the restraint of the VSWR is not indispensable for prevention of the fluctuation of the waveform of the signal as long as the fluctuation of the VSWR is small in the frequency band of the input signal; however, the restraint of the maximum value of the VSWR is usually effective for reducing the fluctuation.

These are the reasons why it is preferable that the VSWR of the antenna be low in the entire frequency band of the signal sent and received by using the antenna.

Therefore, required for realization of an ultra wideband wireless communication such as the UWB communication is an antenna whose VSWR is restrained to be small in a very wide frequency band. Further, the antenna needs to have a small size in consideration of installing the antenna in the mobile information processing apparatus.

The present invention is made in light of the foregoing problems, and its object is to provide a dielectric-loaded antenna which has a small size and which has a small maximum value of the VSWR so as to handle a wider frequency band.

### DISCLOSURE OF INVENTION

To achieve the object, a dielectric-loaded antenna of the present invention includes: (i) a first electrode, which has a conical surface; (ii) a second electrode, which has a flat surface that is so positioned as to face an apex of the conical surface; and (iii) a dielectric member, which is provided between the conical surface and the flat surface, the dielectric member having an outer circumferential surface which has such a slope that extends from a side of the conical surface to a side of the flat surface.

There is a conventional antenna such as a mono-conical antenna, which includes (i) a first electrode having a conical surface and (ii) a second electrode having a flat surface that is so positioned as to face an apex of the conical surface. The conventional antenna uses, as a electricity supply portion, the respective apex-side portions of the first electrode and the second electrode. This makes it possible to handle a wide band. This is advantageous. However, such a conventional antenna handling the wide band inevitably has a large size.

Meanwhile, in the structure described above, the dielectric member is provided between the conical surface and the flat surface so as to allow for an effect (wavelength shortening effect) of shortening the wavelength of an electromagnetic wave. This allows downsizing of the antenna.

Further, the dielectric member of the structure described above has the outer circumferential surface which has such a slope that extends from the side of the conical surface to the side of the flat surface. This makes it possible to lower the maximum value of the VSWR in a wider frequency band, as compared with the case where the dielectric member has a cylindrical outer shape.

As such, the structure above has such a small size, and handles such a wider frequency band in which the maximum value of the VSWR is restrained to be small.

The dielectric-loaded antenna of the present invention is arranged such that: the outer circumferential surface of the dielectric member, a boundary surface between the dielectric member and the conical surface, and a boundary surface between the dielectric member and the flat surface respectively form rotation surfaces whose rotation axes are identical; and the dielectric member has such a cross sectional surface that is taken along a flat surface including the rotation axis, and that has a sector form in which the outer circumferential surface forms an arc and in which each of two sides respectively constituting (i) the boundary surface with the conical surface and (ii) the boundary surface with the flat surface serves as a radius.

As such, the outer circumferential surface of the dielectric member, the boundary surface between the dielectric member and the conical surface, the boundary surface between the dielectric member and the flat surface respectively form the rotation surfaces whose rotation axes are identical. Accordingly, the electromagnetic wave is propagated inside the dielectric member, in a manner substantially symmetrical to the rotation axis. In other words, the electromagnetic wave is propagated along the cross sectional surface of the dielectric member, i.e., along the cross sectional surface taken along a flat surface including the rotation axis.

Further, in the structure above, the cross sectional surface has the sector form in which the outer circumferential surface forms the arc and in which each of two sides respectively constituting (i) the boundary surface with the conical surface and (ii) the boundary surface with the flat surface serves as the radius. This substantially uniformizes a distance from (i) a electricity supply portion positioned in the vicinity of the center of the sector form to (ii) the outer circumferential surface of the dielectric member. This substantially uniformizes, in any propagation direction, the distance that the electromagnetic wave is propagated, from the vicinity of the electricity supply portion, inside the dielectric member. Accordingly, the electromagnetic wave is secured from being reflected complicatedly inside the dielectric member, with the result that the VSWR is restrained from being extremely large.

Alternatively, the dielectric-loaded antenna may be arranged such that: the outer circumferential surface of the dielectric member, a boundary surface between the dielectric member and the conical surface, and a boundary surface between the conical surface and the flat surface respectively form rotation surfaces whose rotation axes are identical; and the dielectric member has such a cross sectional surface that is taken along a flat surface including the rotation axis, and that has a shape of an isosceles triangle having two sides which have identical lengths and which respectively constitutes (i) the boundary surface with the conical surface, and (ii) the boundary surface with the flat surface.

As described above, it is preferable that the cross sectional surface of the dielectric member be in the sector form such that the distance is substantially uniformized from the electricity supply portion to the outer circumferential surface of the dielectric member; however, the cross sectional surface may have the shape of the isosceles triangle similar to the sector form. In cases where the cross sectional surface has the sector form, the outer circumferential surface of the dielectric member corresponds to a spherical surface. On the other hand, in cases where the cross sectional surface corresponds to the isosceles triangle, the outer circumferential surface of the dielectric member corresponds to a conical surface. In general, it is easier to form the dielectric member having the conical outer circumferential surface, as compared with the case of forming the dielectric member having the spherical outer circumferential surface. Therefore, the adoption of the structure above makes it easier to form the dielectric member.

Further, it is preferable that the dielectric-loaded antenna is arranged such that: the dielectric member contains (i) a dielectric member material, and (ii) a conductive particle that is mixed so as to increase a loss coefficient of the dielectric member.

In general, it is preferable that the loss coefficient of the dielectric member used in the antenna be low in the view of improving radiation efficiency. However, in the structure above, the loss coefficient is high to some extent such that the waveform of the electromagnetic wave propagating inside the dielectric member is attenuated. This makes it possible to lower the maximum value of the VSWR.

Further, it is preferable that the dielectric-loaded antenna of the present invention be arranged such that: the dielectric member has a loss efficient of 0.24 or greater.

In the structure above, the dielectric member has a loss coefficient of 0.24 or greater, so that the attenuation of the waveform of the electromagnetic wave propagating inside the dielectric member makes it possible to efficiently lower the VSWR.

To achieve the object, a dielectric-loaded antenna of the present invention includes: (a) a first electrode, which has a conical surface; (b) a second electrode, which has a flat surface that is so positioned as to face an apex of the conical surface; and (c) a dielectric member, which is provided between the conical surface and the flat surface, the dielectric member containing (i) a dielectric member material, and (ii) a conductive particle that is mixed so as to increase a loss coefficient of the dielectric member.

As described above, the antenna including the first electrode and the second electrode can handle the wide band. Further, the dielectric member is provided between the first electrode and the second electrode. This allows the dielectric member to exhibit the wavelength shortening effect. Accordingly, the downsizing of the antenna is attained.

Further, the dielectric member in the structure above contains (i) the dielectric member material, and (ii) the conductive particle that is mixed so as to increase the loss coefficient of the dielectric member. This makes it possible for the dielectric member to have a predetermined loss coefficient.

In general, it is preferable that the loss coefficient of the dielectric member used in the antenna be low in the view of improving radiation efficiency. However, in the structure above, the loss coefficient is high to some extent such that the waveform of the electromagnetic wave propagating inside the dielectric member is attenuated. This makes it possible to lower the maximum value of the VSWR.

As such, the structure above has such a small size, and handles such a wider frequency band in which the maximum value of the VSWR is restrained to be small.

To achieve the object, a dielectric-loaded antenna of the present invention includes: (i) a first electrode, which has a conical surface; (ii) a second electrode, which has a flat surface that is so positioned as to face an apex of the conical surface; and (iii) a dielectric member, which is provided between the conical surface and the flat surface, the dielectric member having a loss efficient of 0.24 or greater.

As described above, the antenna including the first electrode and the second electrode can handle the wide band. Further, the dielectric member is provided between the first electrode and the second electrode. This allows the dielectric member to exhibit the wavelength shortening effect. Accordingly, the downsizing of the antenna is attained.

Further, the dielectric member in the structure has a loss coefficient of 0.24 or greater. In general, it is preferable that the loss coefficient of the dielectric member used in the antenna be low in the view of improving radiation efficiency. However, in the structure above, the dielectric member has a loss coefficient of 0.24 or greater such that the waveform of the electromagnetic wave propagating inside the dielectric member is attenuated. This makes it possible to efficiently lower the VSWR. In this way, the VSWR is lowered.

As such, the structure above has such a small size, and handles such a wider frequency band in which the maximum value of the VSWR is restrained to be small.

To achieve the object, a dielectric-loaded antenna includes: (i) a first electrode, which has a conical surface; (ii) a second electrode, which has a flat surface that is so positioned as to face an apex of the conical surface; and (iii) a dielectric member, which is provided between the conical surface and the flat surface, the dielectric member having a portion whose specific inductive capacity is changed to be smaller in either a continuous manner or a staged manner as the dielectric member extends further from a side close to the apex of the conical surface.

As described above, the antenna including the first electrode and the second electrode can handle the wide band. Further, the dielectric member is provided between the first electrode and the second electrode. This allows the dielectric member to exhibit the wavelength shortening effect. Accordingly, the downsizing of the antenna is attained.

Here, the electromagnetic wave is reflected by the boundary surface, such as the outer circumferential surface of the dielectric member, at which the specific inductive capacity changes. The reflection is caused according to the degree of the change of the specific inductive capacity. The dielectric member in the structure has the portion whose specific inductive capacity is changed to be smaller in either the continuous manner or the staged manner as the dielectric member extends further from the side close to the apex of the conical surface. With this, the electromagnetic wave propagating from the electricity supply portion is reflected, by portions positioned inside the dielectric member, according to the change of the specific inductive capacity.

Specifically, the portions reflecting the electromagnetic wave are distributed inside the dielectric member of the structure described above. Accordingly, reflected waves having different frequencies are distributed. This makes it possible to avoid such a problem that the VSWR in a certain frequency is caused to be large in response to intensive generation of strong reflected waves having the frequency. As the result, the maximum value of the VSWR in the wider frequency band can be lowered.

As such, the structure above has such a small size, and handles such a wider frequency band in which the maximum value of the VSWR is restrained to be small.

Here, as compared with the case where the outer shape of the dielectric member has the cylindrical shape, the maximum value of the VSWR can be further lowered in cases where the dielectric-loaded antenna is arranged such that the outer circumferential surface of the dielectric member has such a slope that extends from the side of the conical surface to the flat surface.

Further, the dielectric member has a multi-layer structure, and can be formed with ease by providing, on top of each other, dielectric members having different specific inductive capacities.

Further, the dielectric member has a loss coefficient which changes in response to the change of the specific inductive capacity of the dielectric member.

To achieve the object, a dielectric-loaded antenna of the present invention includes: (i) a first electrode, which has a first electricity supply portion; (ii) a second electrode, which has a second electricity supply portion; and (iii) a dielectric member, which is provided between the first electrode and the second electrode, the dielectric-loaded antenna having such a cross sectional surface that a distance becomes longer between the first electrode and the second electrode, as the first electrode and the second electrode respectively extend further from the first electricity supply portion and the second electricity supply portion, the dielectric member containing (i) a dielectric member material, and (ii) a conductive particle that is mixed so as to increase a loss coefficient of the dielectric member.

A wide band can be handled by an antenna having such a cross sectional surface that a distance becomes longer between a first electrode and a second electrode, as the first electrode and the second electrode respectively extend further from a first electricity supply portion and a second electricity supply portion. A specific example of such an antenna is mono-conical antenna.

Therefore, the aforementioned structure including the first electrode and the second electrode can handle the wide band. Further, the dielectric member is provided between the first electrode and the second electrode. This allows the dielectric member to exhibit the wavelength shortening effect. Accordingly, the downsizing of the antenna is attained.

Further, in the above structure, the dielectric member contains (i) the dielectric member material and (ii) the conductive particle that is mixed with the dielectric member material so as to increase the loss coefficient of the dielectric member. This makes it possible for the dielectric member to have a predetermined loss coefficient.

In general, it is preferable that the loss coefficient of the dielectric member used in the antenna be low in the view of improving radiation efficiency. However, in the structure above, the loss coefficient is high to some extent such that the waveform of the electromagnetic wave propagating inside the dielectric member is attenuated. This makes it possible to lower the maximum value of the VSWR.

As such, the structure above has such a small size, and handles such a wider frequency band in which the maximum value of the VSWR is restrained to be small.

To achieve the object, a dielectric-loaded antenna of the present invention includes: (i) a first electrode, which has a first electricity supply portion; (ii) a second electrode, which has a second electricity supply portion; and (iii) a dielectric member, which is provided between the first electrode and the second electrode, the dielectric-loaded antenna having such a cross sectional surface that a distance becomes longer between the first electrode and the second electrode as the first electrode and the second electrode respectively extend further from the first electricity supply portion and the second electricity supply portion, the dielectric member having a loss coefficient of 0.24 or greater.

As described above, the antenna including the first electrode and the second electrode can handle the wide band. Further, the dielectric member is provided between the first electrode and the second electrode. This allows the dielectric member to exhibit the wavelength shortening effect. Accordingly, the downsizing of the antenna is attained.

Further, in the above structure, the dielectric member has a loss efficient of 0.24 or greater. In general, it is preferable that the loss coefficient of the dielectric member used in the antenna be low in the view of improving radiation efficiency. However, in the structure above, the loss coefficient is 0.24 or greater such that the waveform of the electromagnetic wave propagating inside the dielectric member is attenuated. This makes it possible to lower the maximum value of the VSWR.

As such, the structure above has such a small size, and handles such a wider frequency band in which the maximum value of the VSWR is restrained to be small.

To achieve the object, a dielectric-loaded antenna of the present invention includes: (i) a first electrode, which has a first electricity supply portion; (ii) a second electrode, which has a second electricity supply portion; and (iii) a dielectric member, which is provided between the first electrode and the second electrode, the dielectric-loaded antenna having such a cross sectional surface that a distance becomes longer between the first electrode and the second electrode as the first electrode and the second electrode respectively extend further from the first electricity supply portion and the second electricity supply portion, the dielectric member having such a specific inductive capacity that is changed to be smaller in either a continuous manner or a staged manner as the dielectric member further extends from each of the first electrode and the second electrode in the cross sectional surface.

As described above, the antenna including the first electrode and the second electrode can handle the wide band. Further, the dielectric member is provided between the first electrode and the second electrode. This allows the dielectric member to exhibit the wavelength shortening effect. Accordingly, the downsizing of the antenna is attained.

Here, the electromagnetic wave is reflected by the boundary surface, such as the outer circumferential surface of the dielectric member, at which the specific inductive capacity changes. The dielectric member in the structure has the portion whose specific inductive capacity is changed to be smaller in either the continuous manner or the staged manner as the dielectric member extends further from the side close to the apex of the conical surface. With this, the electromagnetic wave propagating from the electricity supply portion is reflected, by portions positioned inside the dielectric member, according to the change of the specific inductive capacity.

Specifically, the portions reflecting the electromagnetic wave are distributed inside the dielectric member of the structure described above. Accordingly, reflected waves having different frequencies are distributed. This makes it possible to avoid such a problem that the VSWR in a certain frequency is caused to be large in response to intensive generation of strong reflected waves having the frequency. As the result, the maximum value of the VSWR in the wider frequency band can be lowered.

As such, the structure above has such a small size, and handles such a wider frequency band in which the maximum value of the VSWR is restrained to be small.

The dielectric-loaded antenna having any one of the aforementioned cross sectional surface may be so arranged as to form a rotation body obtained by rotating the cross sectional surface with respect to a rotation axis meeting each of the electricity supply portions.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a perspective view illustrating a mono-conical antenna according to Embodiment 1 of the present invention.

FIG. 2 is a cross sectional view illustrating a mono-conical antenna shown in FIG. 1.

FIG. 3(a) is an explanatory cross sectional view illustrating radiation of an electromagnetic wave from the mono-conical antenna shown in FIG. 1. FIG. 3(b) is a diagram illustrating a relation among an incoming wave, a radiation wave, and a reflected wave in the mono-conical antenna shown in FIG. 1.

FIG. 4 is a graph illustrating a radiation efficiency change caused by changing a dielectric dissipation factor in the mono-conical antenna shown in FIG. 1.

FIG. 5 is a graph illustrating a VSWR change caused by changing the dielectric dissipation factor in the mono-conical antenna shown in FIG. 1.

FIG. 6 is a graph obtained by converting the dielectric constant in the graph of FIG. 4 into a loss coefficient.

FIG. 7 is a graph obtained by converting (i) the dielectric constant in the graph of FIG. 5 into (ii) a loss coefficient.

FIG. 8 is a graph illustrating the frequency-VSWR property of a mono-conical antenna having no dielectric member.

FIG. 9 is a graph illustrating the frequency-VSWR property of the mono-conical antenna shown in FIG. 1.

FIG. 10(a) through FIG. 10(e) are cross sectional views respectively illustrating shapes 1 through 5 of the mono-conical antennas, and the shapes 1 through 5 are obtained by changing the shapes of the dielectric members, respectively.

FIG. 11 is a table illustrating (i) wavelength shortening effect and (ii) the VSWR of each of the mono-conical antennas respectively having the shapes 1 through 5.

FIG. 12 is a graph illustrating a difference in the wavelength shortening effect, among the mono-conical antennas respectively having the shapes 1 through 5.

FIG. 13 is a graph illustrating a difference in the VSWR, among the mono-conical antennas respectively having the shapes 1 through 5.

FIG. 14 is a graph illustrating the frequency-VSWR property of the mono-conical antenna having the shape 1.

FIG. 15 is a perspective view illustrating one modified example of the mono-conical antenna shown in FIG. 1.

FIG. 16 is a cross sectional view illustrating the mono-conical antenna shown in FIG. 15.

FIG. 17 is an explanatory perspective view illustrating a method for manufacturing the mono-conical antenna shown in FIG. 1.

FIG. 18 is an explanatory perspective view illustrating a method for manufacturing the mono-conical antenna shown in FIG. 15.

FIG. 19 is a perspective view illustrating a mono-conical antenna according to Embodiment 2 of the present invention.

FIG. 20 is a cross sectional view illustrating the mono-conical antenna shown in FIG. 19.

FIG. 21(a) is an explanatory cross sectional view illustrating how an electromagnetic wave is transmitted by the mono-conical antenna shown in FIG. 19, and FIG. 21(b) is a diagram illustrating a relation among (i) an incoming wave in the mono-conical antenna shown in FIG. 19, (ii) a radiation wave therein, and (iii) a reflected wave therein.

FIG. 22 is a graph illustrating a frequency-VSWR property of the mono-conical antenna shown in FIG. 19.

FIG. 23 is a perspective view illustrating a modified example of the mono-conical antenna shown in FIG. 19.

FIG. 24 is a cross sectional view illustrating the mono-conical antenna shown in FIG. 23.

FIG. 25(a) through FIG. 25(e) are cross sectional views respectively illustrating cross sections of the mono-conical antenna shown in FIG. 19, which cross sections are respectively obtained in stages of a process of the mono-conical antenna shown in FIG. 19.

FIG. 26(a) is a cross sectional view illustrating another example of a mono-conical antenna according to the present invention. FIG. 26(b) is a cross sectional view illustrating still another example of a mono-conical antenna according to the present invention.

FIG. 27 is a perspective view illustrating a conventional dielectric vertically polarized wave antenna.

FIG. 28 is a cross sectional view illustrating the dielectric vertically polarized wave antenna shown in FIG. 27.

### BEST MODE FOR CARRYING OUT THE INVENTION

### Embodiment 1

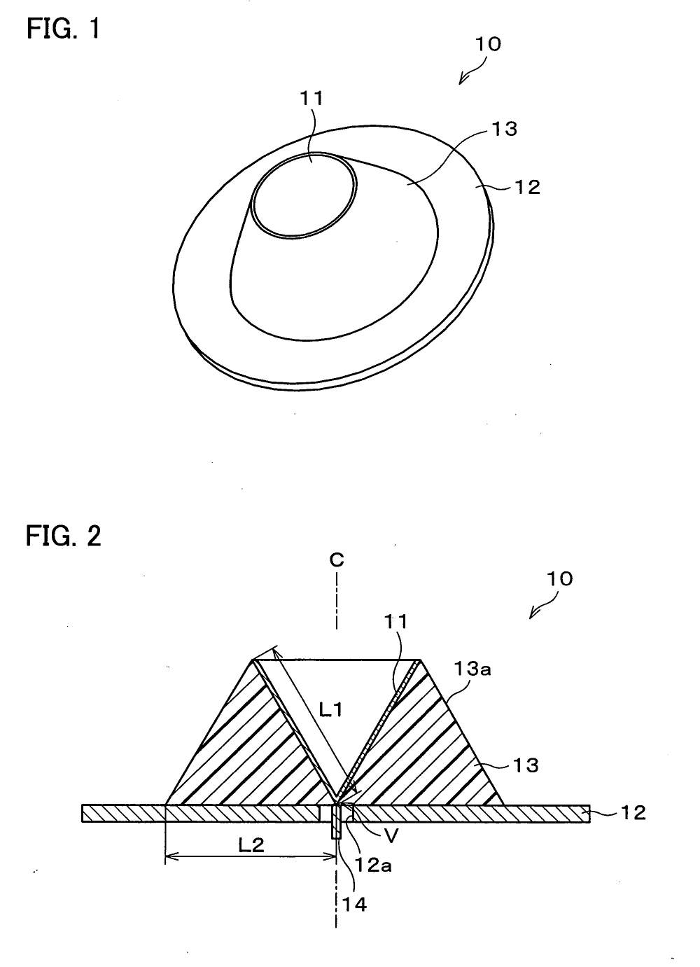

Embodiment 1 of the present invention will be described below with reference to FIG. 1 through FIG. 18, and FIG. 26.

FIG. 1 is a perspective view illustrating a mono-conical antenna 10 of the present embodiment, and FIG. 2 is a cross sectional view illustrating the mono-conical antenna 10. The mono-conical antenna 10 includes a electricity supply electrode 11, an earth electrode 12, a dielectric member 13, and a electricity supply terminal 14.

The electricity supply electrode 11 is an electrode made of a conductor, and forms a conical surface of a circular cone. The electricity supply electrode 11 is formed by, e.g., carrying out plating with respect to the inner surface of the dielectric member 13.

The earth electrode 12 is an electrode made of a conductor, and has a shape of a circular plate, and has a through hole 12a which has a cylindrical shape and which has a center concentric with the center of the earth electrode 12. The earth electrode 12 is so provided that the earth electrode 12 is perpendicular to the center line of the conical surface constituted by the electricity supply electrode 11, and that the center line of the electricity supply electrode 11 meets the center of the through hole 12a, and that the apex V of the conical surface constituted by the electricity supply electrode 11 (apex V of the electricity supply electrode 11) is positioned in a position as high as the surface (upper surface), which faces the electricity supply electrode 11, of the earth electrode 12. Specifically, the center line of the conical surface constituted by the electricity supply electrode 11, the center line of the circular plate constituting the earth electrode 12, and the center line of the cylinder constituting the through hole 12a correspond to the same center line C. The earth electrode 12 is made of, e.g., a metal plate material.

The dielectric member 13 is made of a dielectric material, and is so provided between the electricity supply electrode 11 and the earth electrode 12 as to fill a space therebetween. The dielectric member 13 has an outer circumferential surface 13a constituting a part of a conical surface different from the conical surface constituted by the electricity supply electrode 11. Therefore, the dielectric member 13 has such a shape that: a cross sectional surface taken along a flat surface encompassing the center line C has two triangles symmetrical to each other with respect to the center line C, and the cross sectional surface having the triangles are rotated with respect to the center line C. Each of the triangles in the cross sectional surface of the dielectric member 13 has (i) a side meeting the electricity supply electrode 11, (ii) a side meeting the upper surface of the earth electrode 12, and (iii) a side constituting the outer circumferential surface 13a of the dielectric member 13. Further, the side meeting the electricity supply electrode 11 has a length L1 that is as long as the length L2 of the side meeting the upper surface of the earth electrode 12. The dielectric member 13 can be formed by, e.g., carrying out injecting molding with respect to a resin with the use of a metal pattern having a predetermined shape.

The electricity supply terminal 14 is a terminal made of a conductor, and has a cylindrical shape. The electricity supply terminal 14 is so provided in the through hole 12a of the earth electrode 12 that the center line of the electricity supply terminal 14 is coincide with the center line C. The electricity supply terminal 14 is separated from the inner circumferential surface of the through hole 12a of the earth electrode 12, so that the electricity supply terminal 14 is electrically insulated from the earth electrode 12. Further, the electricity supply terminal 14 has one end attached to the apex V of the electricity supply electrode 11, so that the electricity supply terminal 14 is electrically connected to the electricity supply electrode 11. Hereinafter, the portion in which the electricity supply terminal 14 and the electricity supply electrode 11 are connected with each other, i.e., the apex V of the electricity supply electrode 11 is referred to as “electricity supply portion”. The electricity supply terminal 14 is made of, e.g., a metal material having a bar or cylindrical shape. Further, the connection between the electricity supply terminal 14 and the electricity supply electrode 11 can be attained by, e.g., using a silver paste.

For attainment of transmission and reception of electromagnetic waves by using such a mono-conical antenna 10, a cable such as a coaxial cable is connected to the center of the mono-conical antenna 10 via the earth electrode 12. Specifically, an inner conductor (core wire) of the coaxial cable is connected to the electricity supply terminal 14, and an outer conductor (shield) of the coaxial cable is connected to the vicinity of the through hole 12a of the earth electrode 12. For attainment of the connection, the earth electrode 12 is provided with a connector (not shown) by which the earth electrode 12 is connected to the coaxial cable. Note that the connector may not be provided and the coaxial cable may be connected directly to the earth electrode 12.

For ease of explanation, the following explains a property of the mono-conical antenna and the like in cases where each of the electromagnetic waves is transmitted via the mono-conical antenna. However, the property etc., are substantially the same in cases where the electromagnetic wave is received via the mono-conical antenna. In other words, the mono-conical antenna can be used for the transmission and the reception of the electromagnetic wave.

Further, the following assumes a case of transmitting an electromagnetic wave having a high frequency falling within the band which ranges from 3.1 GHz to 10.6 GHz and which is as wide as the frequency band of the UWB communication.

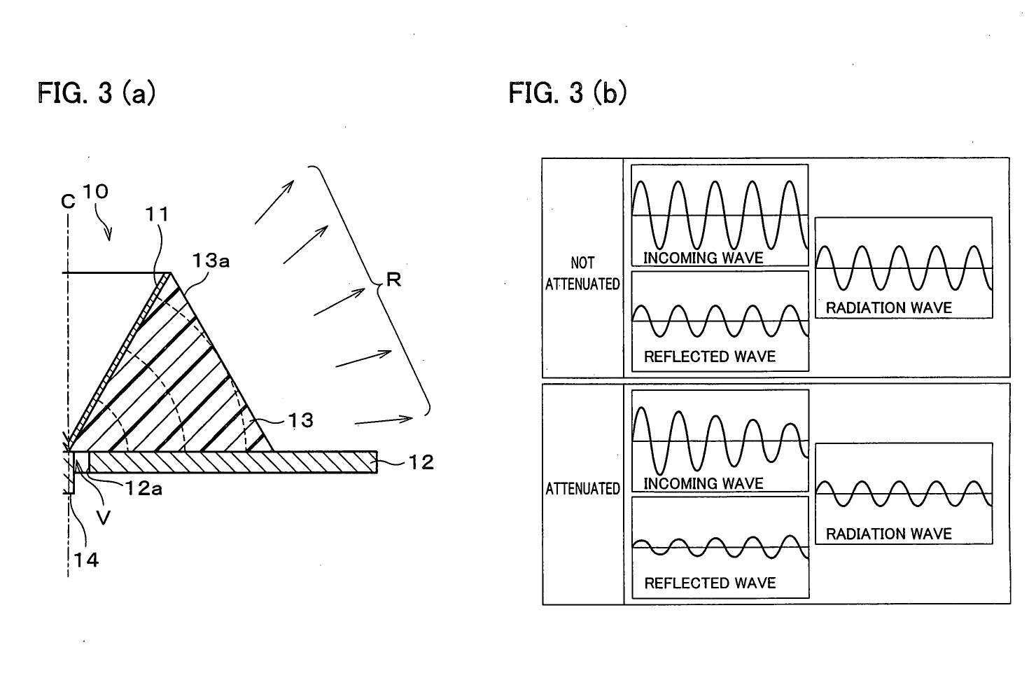

Explained next is an influence of providing the dielectric member 13 over the antenna property, with reference to FIG. 3 through FIG. 9.

When transmitting the electromagnetic wave from the mono-conical antenna 10, an electric power is fed to the apex V of the electricity supply electrode 11 such that the high frequency electromagnetic wave is generated. The electromagnetic wave thus generated is diffused and propagated between the electricity supply electrode 11 and the earth electrode 12 as indicated by the broken line of FIG. 3(a). In other words, the high frequency wave is diffused and propagated inside the dielectric member 13, concentrically with respect to the apex V. The dielectric member 13 works to shorten the wavelength of the electromagnetic wave. Accordingly, the wavelength of the electromagnetic wave inside the dielectric member 13 becomes shorter as compared with the wavelength thereof outside the dielectric member 13 according to a specific inductive capacity ∈1 of the dielectric member 13.

Note that the present specification defines the specific inductive capacity of the dielectric member 13 as a ratio “∈1/∈0”, i.e., as a ratio of (i) a dielectric constant ∈0 of a space (outer space; normally, air space) to which the electromagnetic wave is radiated from the mono-conical antenna 10, and (ii) a dielectric constant ∈1 of the dielectric member 13.

The above definition is identical to the general definition of the specific inductive capacity in cases where the outer space is the air space. However, in cases where the mono-conical antenna 10 is used in water, the outer space is water, so that the specific inductive capacity of the dielectric member 13 indicates a ratio of (i) a dielectric constant of the water and (ii) the dielectric constant of the dielectric member 13. The following description assumes that the outer space is the air space, unless otherwise noted.

As such, the mono-conical antenna 10 having the dielectric member 13 makes it possible to shorten the wavelength of the electromagnetic wave. Accordingly, the mono-conical antenna 10 having the dielectric member 13 can transmit an electromagnetic wave having longer wavelength, i.e., can transmit an electromagnetic wave having shorter frequency as compared with that of an electromagnetic wave transmitted from an mono-conical antenna 10 which has no dielectric member and which has the same size as that of the mono-conical antenna 10. Moreover, in cases where the mono-conical antenna 10 is so set as to have the same lower frequency limit as that of the mono-conical antenna having no dielectric member, the mono-conical antenna 10 has a size smaller than that of the mono-conical antenna having no dielectric member.

This is specifically explained as follows. That is, a size required for attainment of the low frequency limit of 3.1 GHz in such a mono-conical antenna 10 is that: e.g., the power electrode 11 has a maximum diameter (diameter of a portion corresponding to the bottom surface of the circular cone) of 12 mm, and the earth electrode 12 has a diameter of 34 mm, and the dielectric member 13 has a height (height in the direction of the center line C) of 16 mm, and each of L1 and L2 is 17 mm. Note that the dielectric member 13 has a specific inductive capacity of 12 in this case. In contrast, a size required for attainment of the lower frequency limit of 3.1 GHz in the mono-conical antenna having no dielectric member is that: the electricity supply electrode 11 has a maximum diameter of approximately 200 mm to approximately 300 mm.

As such, the mono-conical antenna 10 having the dielectric member 13 has a size smaller than 1/10 of that of the mono-conical antenna 10 having no dielectric member.

As described above, the electromagnetic wave is diffused and propagated inside the dielectric member 13, concentrically with respect to the apex V. The electromagnetic wave thus diffused and propagated is radiated, in the electromagnetic wave radiation direction R, from the outer circumferential surface 13a of the dielectric member 13 to the outer space. The electromagnetic wave radiation direction R substantially corresponds to the radial direction of a portion, positioned in the space between the electricity supply electrode 11 and the earth electrode 12, of the surface of a sphere concentric with the apex V.

Here, when the electromagnetic wave is radiated from the dielectric member 13 to the outer space, i.e., when the electromagnetic wave passes through the outer circumferential surface 13a which is a boundary between the dielectric member 13 and the outer space, the electromagnetic wave is reflected due to the difference between the dielectric constant of the dielectric member 13 and the dielectric constant of the outer space. Therefore, although a part of the electromagnetic wave (incoming wave) coming into the outer circumferential surface 13a is radiated to the outer space as a radiation wave, another part of the electromagnetic wave is reflected to be a reflected wave coming back to the inside of the dielectric member 13 as shown in FIG. 3(b). When dielectric loss is sufficiently small in the dielectric member 13, the incoming wave and the reflected wave are substantially free from attenuation; however, as the dielectric loss increases, the incoming wave and the reflected wave are attenuated while propagating in the dielectric member 13.

The following explains an effect of the aforementioned attenuation of the waveform. Normally, a dielectric-loaded antenna including a dielectric member is formed such that the dielectric loss is as small as possible for the sake of improving the radiation efficiency. In contrast, the dielectric loss is large in the mono-conical antenna 10. Such large dielectric loss causes the attenuation of the waveform, with the result that the radiation efficiency is decreased. The attenuation of the waveform renders such an adverse effect, but also allows the mono-conical antenna 10 to cover a wider band. This is advantageous.

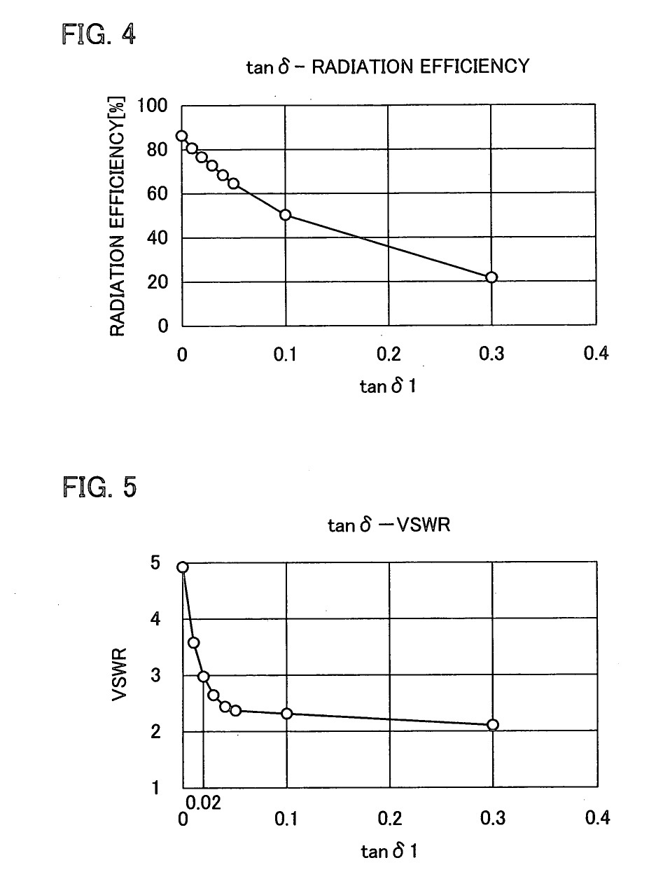

This will be explained with reference to respective graphs of FIG. 4 and FIG. 5. Note that the dielectric constant ∈1 of the dielectric member 13 is invariable in each of the graphs. A dielectric loss coefficient in the dielectric member 13 is changed by changing a dielectric dissipation factor (tan δ1) of the dielectric member 13, so that the dielectric loss becomes larger as the tan δ1 becomes larger. Further, the vertical axis of the graph of FIG. 5 indicates a maximum value of the VSWR (Voltage Standing Wave Ratio) in the frequency band ranging from 3.1 GHz to 10.6 GHz. The maximum value of the VSWR serves as an index indicating the width of the band covered by the mono-conical antenna 10.

The graph of FIG. 4 clarifies that the radiation efficiency is decreased at a substantially fixed rate as the tan δ1 becomes larger.

The graph of FIG. 5 clarifies that the VSWR is decreased as the tan δ1 becomes larger, i.e., the graph of FIG. 5 clarifies that the band covered by the mono-conical antenna 10 is widened as the tan δ1 becomes larger. The VSWR is decreased at an unfixed rate in response to the change of the tan δ1. Specifically, the VSWR is decreased dramatically when the tan δ1 is changed from 0 to 0.02. After the tan δ1 becomes 0.02 or larger, the degree of the decrease of the VSWR becomes gradually smaller.

In the view of widening the band covered by the mono-conical antenna 10, it is preferable to set the tan δ1 at 0.02 or greater. Moreover, in the view of preventing the decrease of the radiation efficiency as much as possible, it is not preferable to set the tan δ1 at a very large value. Specifically, it is preferable that the tan δ1 is 0.1 or less such that the radiation efficiency is maintained at 50% or greater.

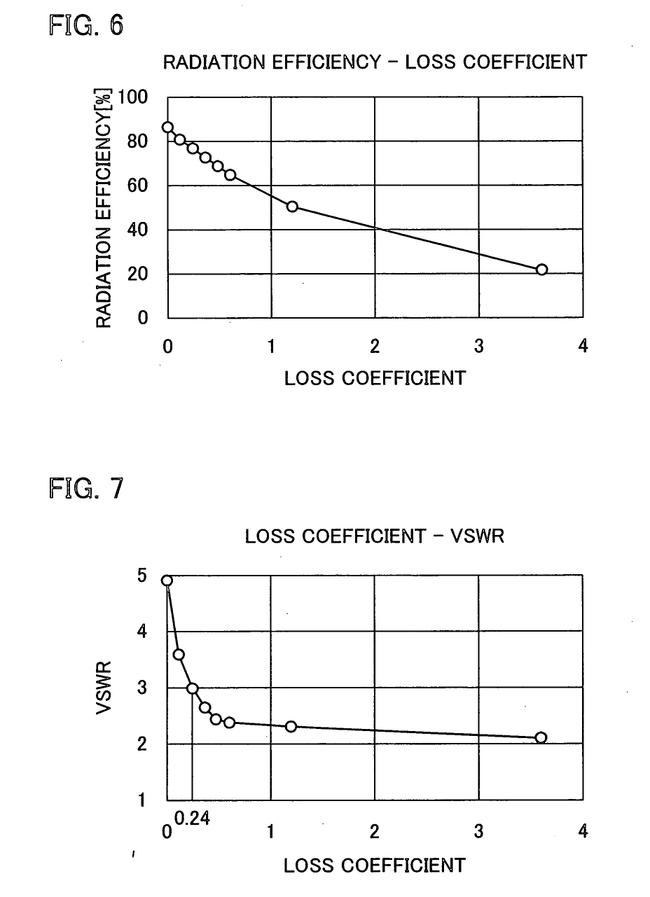

The loss coefficient is not changed according to the dielectric constant ∈1, so that the loss coefficient is used to define the dielectric loss. Note that the loss coefficient refers to a value found by multiplying (i) a specific inductive capacity (the specific inductive capacity here is different from the one defined in the present specification, and is always the ratio found based on the dielectric constant of the air space) by (ii) the dielectric dissipation factor. Now, see FIG. 6 and FIG. 7, each of which uses the loss coefficient converted from the tan δ1 (see FIG. 4 and FIG. 5) in accordance with the specific inductive capacity 12 of the dielectric member 13. In the view of widening the band covered by the mono-conical antenna 10, it is preferable that the loss coefficient of the dielectric member 13 be set at 0.24 or greater. Moreover, in the view of preventing the decrease of the radiation efficiency as much as possible, it is preferable that the loss coefficient of the dielectric member 13 be 1.2 or less.

As described above, the mono-conical antenna 10 including the dielectric member 13 having such large tan δ1 has the small size and covers the wide band.

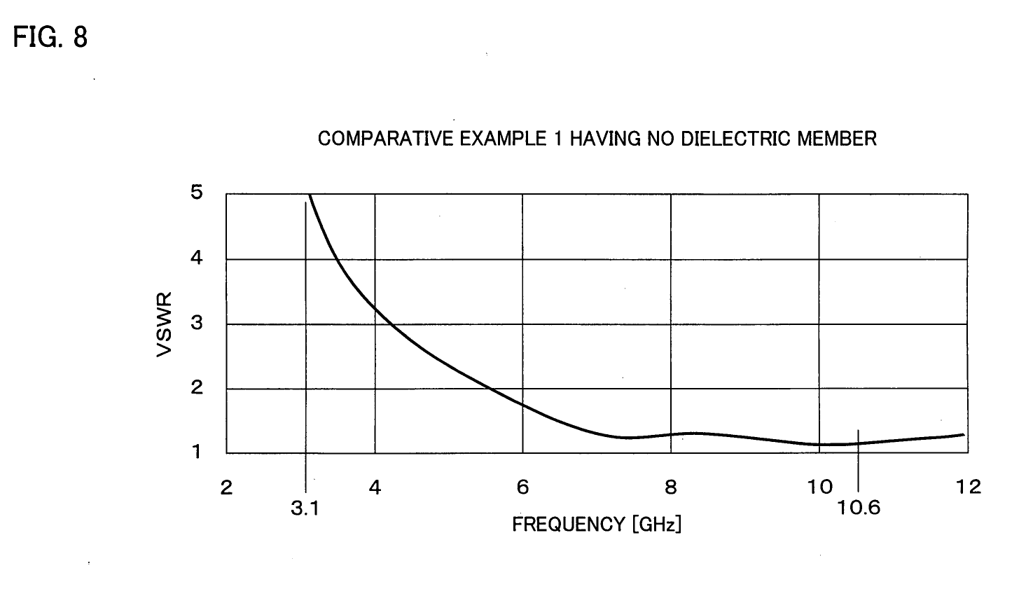

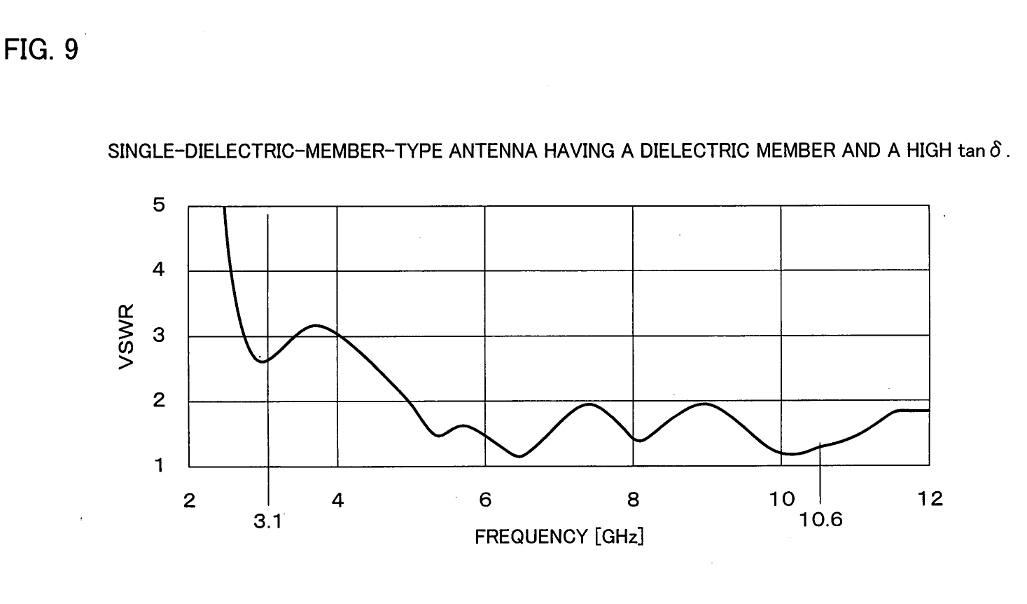

This can be seen in respective graphs of FIG. 8 and FIG. 9. The graph of FIG. 8 pertains to Comparative Example 1, and illustrates a result of simulating, with the use of a mono-conical antenna obtained by omitting the dielectric member 13 from the mono-conical antenna 10, a change of the VSWR in the frequency band ranging from 3.1 GHz to 10.6 GHz. On the other hand, the graph of FIG. 9 illustrates a result of simulating, with the use of the mono-conical antenna 10, a change of the VSWR in the frequency band ranging from 3.1 GHz to 10.6 GHz.

In Comparative Example 1, there is no dielectric member allowing the wavelength shortening effect and the waveform attenuation effect, so that the VSWR is high on the low frequency side.

In contrast, the mono-conical antenna 10 allows the wavelength shortening effect and the waveform attenuation effect, so that the VSWR is suitably lowered on the low frequency side. Normally, the property required for an antenna is that the maximum value of the VSWR in a frequency band to be used falls within a range from approximately 2 to approximately 3. The mono-conical antenna 10 satisfies this condition.

Note that the adjustment of the dielectric constant ∈1 and of the tan δ1 of the dielectric member 13 can be realized by adjusting the material of which the dielectric member 13 is made. Specifically, the dielectric member 13 used here is made of a resin, and the dielectric constant δ1 is adjusted by mixing ceramics with the resin, and the tan δ1 is adjusted by mixing conductive particles with the resin.

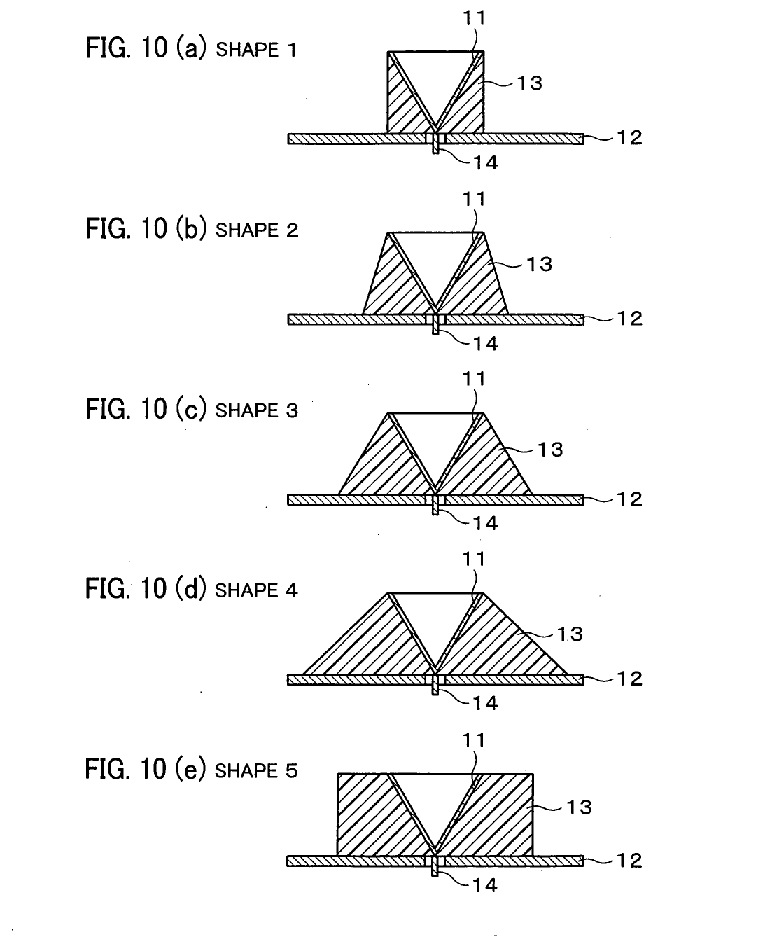

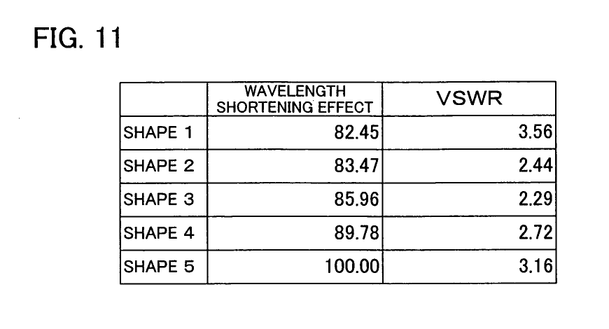

Explained next is how the shape of the dielectric member 13 influences the antenna property, with reference to FIG. 10(a) through FIG. 10(e), and FIG. 11 through FIG. 14.

FIG. 10(a) through FIG. 10(e) respectively illustrate shapes 1 through 5 of mono-conical antennas. Each shape of the mono-conical antennas is obtained by changing the shape of the dielectric member 13 of the mono-conical antenna 10. The shape 3 of the mono-conical antenna shown in FIG. 10(c) corresponds to the shape of the mono-conical antenna 10 shown in FIG. 1 and FIG. 2. The same reference numerals as those of the electricity supply electrode 11, the earth electrode 12, the dielectric member 13, the electricity supply terminal 14 of the mono-conical antenna 10 are rendered to corresponding members shown in FIG. 10(a) through FIG. 10(e) illustrating the shapes 1 through 5, respectively.

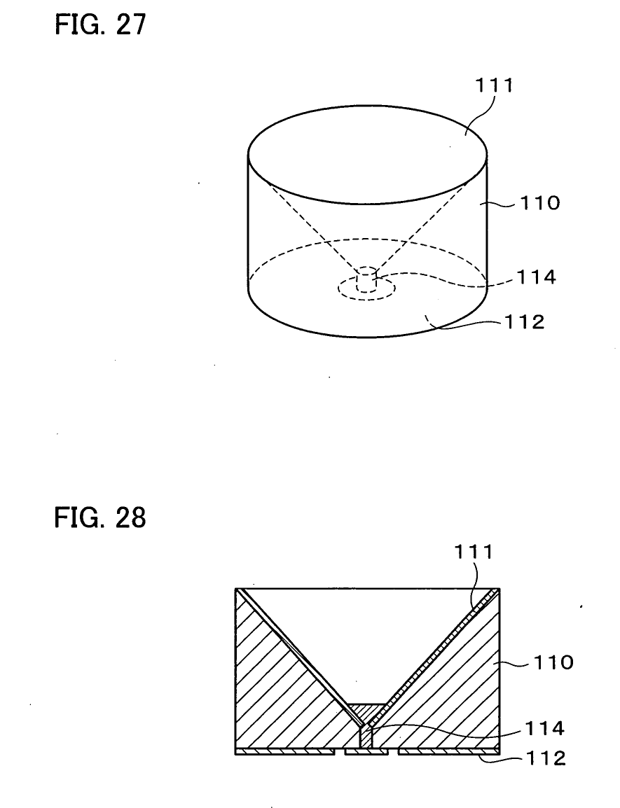

The following explains the shapes 1, 2, 4, and 5. The shape 1 is obtained by forming the dielectric member 13 such that the outer circumferential surface of the dielectric member 13 forms a cylindrical shape. Therefore, the shape 1 is similar to the shape of the conventional dielectric vertically polarized wave antenna shown in FIG. 27 and FIG. 28. The shape 2 is obtained by changing the relation between L1 and L2 (see FIG. 2) in the mono-conical antenna 10 such that L1 is larger than L2. On the other hand, the shape 4 is obtained by changing the relation between L1 and L2 (see FIG. 2) in the mono-conical antenna 10 such that L1 is smaller than L2. The shape 5 is obtained by enlarging the diameter of the dielectric member 13 of the mono-conical antenna having the shape 1.

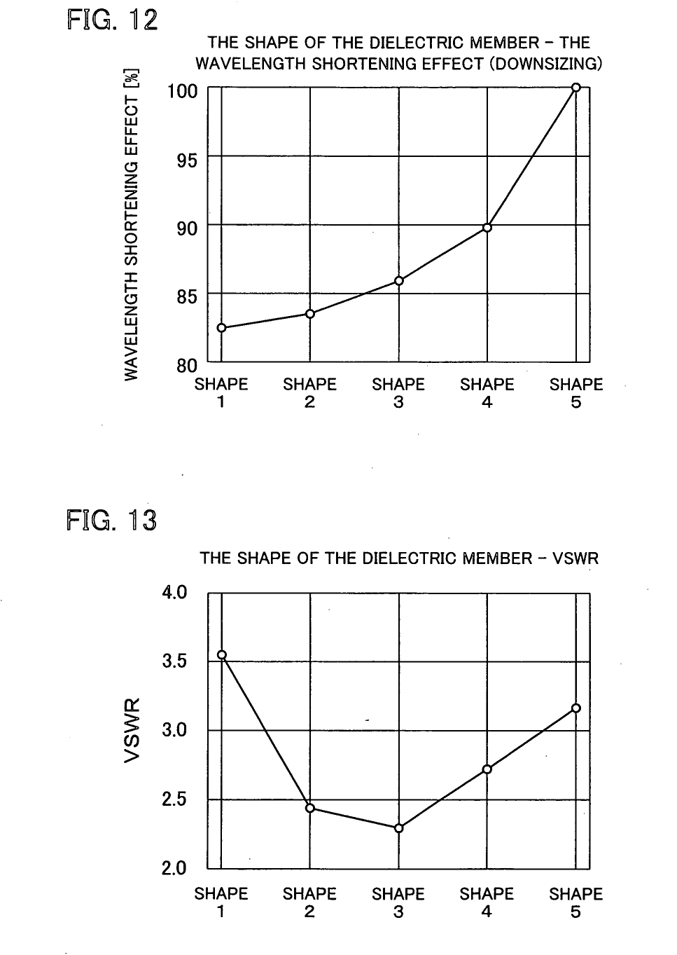

Each of FIG. 11 through FIG. 13 illustrates a result of simulation for finding the wavelength shortening effect and the VSWR of each of the mono-conical antennas respectively having the shapes 1 through 5. FIG. 11 illustrates the result of the simulation. FIG. 12 is a graph illustrating the wavelength shortening effect found as the result of the simulation. FIG. 13 is a graph illustrating the VSWR found as the result of the simulation.

Here, the wavelength shortening effect in the simulation result is evaluated in accordance with a wavelength of an electromagnetic wave transmitted from each of the mono-conical antennas, which wavelength is obtained when the VSWR firstly has become a predetermined value, specifically 2.5 or less, by changing the frequency of the electromagnetic wave from a low frequency (long wavelength) to a high frequency (short wavelength). The wavelength shortening effect is expressed by way of percentage with respect to the wavelength shortening effect of the mono-conical antenna having the shape 5. Meanwhile, the VSWR in the simulation result is evaluated in accordance with the maximum value of the VSWR in the frequency band ranging from 3.1 GHz to 10.6 GHz.

See FIG. 12. It is apparent that: the mono-conical antenna having the shape 5 allows the best wavelength shortening effect, and the mono-conical antenna having the shape 4 allows the second best wavelength shortening effect, and the mono-conical antenna having the shape 3 allows the third best wavelength shortening effect, and the mono-conical antenna having the shape 2 allows the fourth best wavelength shortening effect, and the mono-conical antenna having the shape 1 allows the worst wavelength shortening effect. This indicates that the wavelength shortening effect is influenced by (i) the maximum distance from the electricity supply portion (apex V) to the boundary between the dielectric member 13 and the outer space, and (ii) the minimum distance therefrom. Therefore, as the maximum distance and minimum distance are larger, the wavelength shortening effect is larger.

Meanwhile, see FIG. 13. It is apparent that: the mono-conical antenna having the shape 3 has the smallest VSWR, and the mono-conical having the shape 2 has the second smallest VSWR, and the mono-conical having the shape 4 has the third smallest VSWR, and the mono-conical having the shape 5 has the fourth smallest VSWR, and the mono-conical having the shape 1 has the largest VSWR. This indicates that the VSWR is influenced by unevenness in distance from the electricity supply portion (apex V) to the boundary between the dielectric member 13 and the outer space. Therefore, as the unevenness is smaller, the VSWR is smaller.

See the following example. That is, the shape 3 is such a shape that the outer circumferential surface 13a of the dielectric member 13 is similar to the surface of a sphere whose center corresponds to the electricity supply portion. Therefore, the distance from the electricity supply portion to the boundary between the dielectric member 13 and the outer space is substantially even in the outer circumferential surface 13a.

On the other hand, the shape 1 is such a shape that: the distance from the electricity supply portion to the boundary between the dielectric member 13 and the outer space is maximum in the direction of a generator of the circular cone of the electricity supply electrode 11, and is minimum in the radial direction of the earth electrode 12. Moreover, difference is large between the maximum distance and the minimum distance.

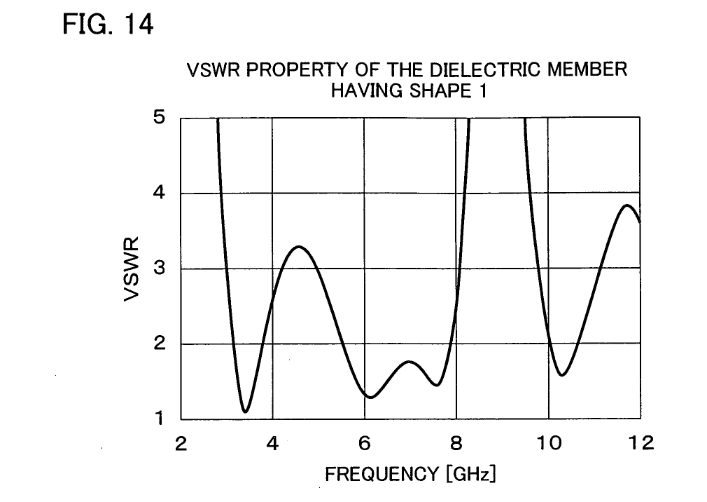

FIG. 14 illustrates the result of the simulation of changing the VSWR of the mono-conical antenna having the shape 1, in the frequency band ranging from 3.1 GHz to 10.6 GHz. As shown in FIG. 14, the VSWR of the mono-conical antenna having the shape 1 is suitably lowered in the low frequency side of the frequency band ranging from 3.1 GHz to 10.6. GHz. However, the peak of the VSWR in a frequency range of 4 GHz to 10 GHz is high. A reason of this is as follows. That is, in the antenna having the shape 1, the great unevenness in the distance from the electricity supply portion to the boundary between the dielectric member 13 and the outer space causes complicated reflection of the electromagnetic wave.

For this reason, it is preferable to form the dielectric member 13 such that the outer circumferential surface 13a is in the form similar to the surface of the sphere whose center is the electricity supply portion. For example, it is apparently preferable to form the dielectric member 13 such that the mono-conical antenna has the shape 3, i.e., such that the outer circumferential surface 13a forms a part of the surface (slope) of the circular cone inclining toward the earth electrode 12, and such that L1 and L2 have the same length.

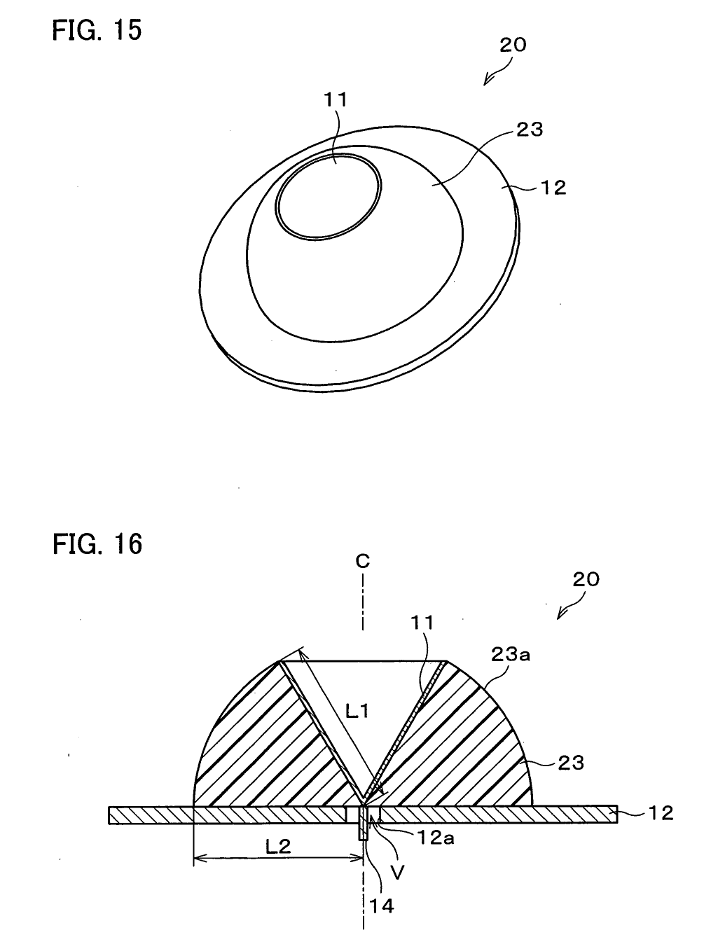

The following explains a mono-conical antenna 20 with reference to FIG. 15 and FIG. 16. The mono-conical antenna 20 is a modified example of the mono-conical antenna 10.

As described above, it is preferable to form the dielectric member such that the outer circumferential surface is in the form similar to the surface of the sphere whose center is the electricity supply portion. Therefore, the mono-conical antenna 20 is arranged such that an outer circumferential surface 23a of the dielectric member 23 is in the form of the surface of the sphere whose center is the electricity supply portion. Apart from this, the structure of the mono-conical antenna 20 is the same as that of the mono-conical antenna 10.

Although the mono-conical antenna 10 allows sufficient lowering of the maximum value of the VSWR in the frequency band ranging from 3.1 GHz to 10.6 GHz, the mono-conical antenna 20 allows further lowering thereof. However, it is easier to form the outer circumferential surface 13a of the mono-conical antenna 10 as compared with that of the mono-conical antenna 20. Therefore, in consideration of (i) the effect of lowering the VSWR and (ii) easiness in manufacturing, a mono-conical antenna to be employed can be selected arbitrarily from the mono-conical antennas 10 and 20.

As such, the outer circumferential surface 13a of the dielectric member 13, the boundary surface between the dielectric member 13 and the electricity supply electrode 11, the boundary surface between the dielectric member 13 and the earth electrode 12 respectively constitute rotation surfaces whose rotation axes are the same (center line C). Also, the outer circumferential surface 23a of the dielectric member 23, the boundary surface between the dielectric member 23 and the electricity supply electrode 11, and the boundary surface between the dielectric member 23 and the earth electrode 12 respectively constitute rotation surfaces whose rotation axes are the same (center line C). It is preferable that each of the dielectric members 13 and 23 have the following cross sectional surface taken along a flat surface encompassing the rotation axis. That is, it is preferable that the cross sectional surface form an isosceles triangle, in which the side constituting the boundary surface with the electricity supply electrode 11 has the same length as that of the side constituting the boundary surface with the earth electrode 12. Alternatively, it is preferable that: the cross sectional surface have an arc outer circumferential surface 23a and have a sector form whose radius corresponds to each of (i) the boundary surface with the electricity supply electrode 11, and (ii) the boundary surface with the earth electrode 12.

This allows prevention of the complicated reflection occurring inside the dielectric member 13 or 23, so that the VSWR can be restrained from being extremely large.

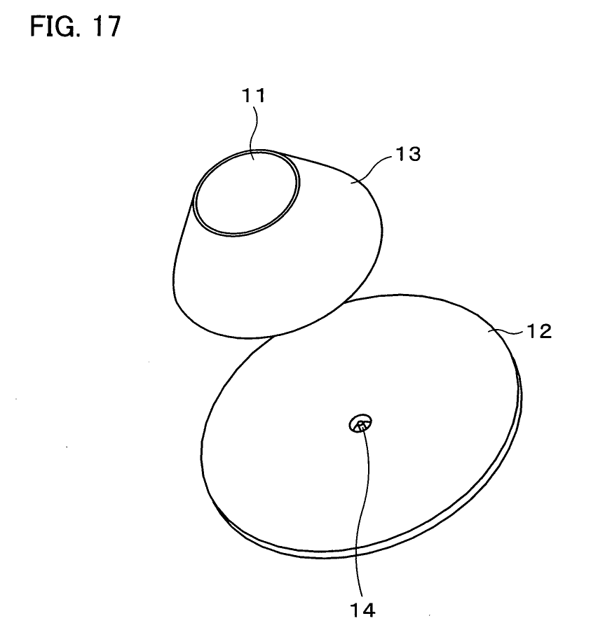

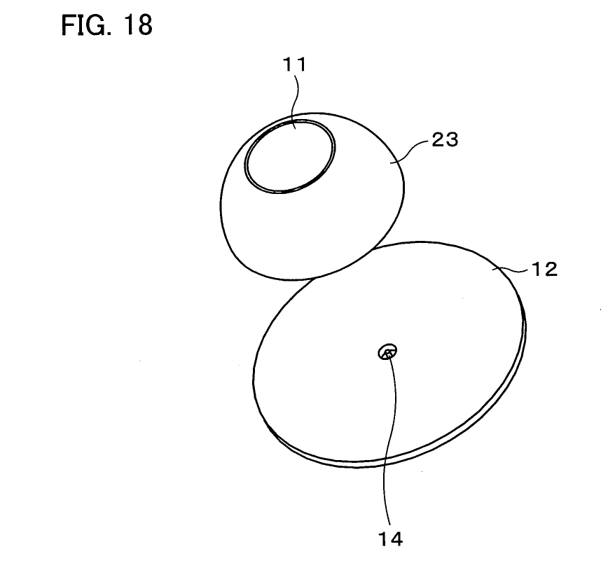

Explained next is one example of a method for manufacturing the mono-conical antennas 10 and 20, with reference to FIG. 17 and FIG. 18. Note that the mono-conical antennas 10 and 20 can be manufactured in accordance with substantially the same method, so that the following explanation assumes the method for manufacturing the mono-conical antenna 10.

Firstly carried out is formation of the dielectric member 13. The dielectric member 13 can be formed by carrying out the injection molding with respect to the resin with the use of the metal pattern. As described above, the dielectric member 13 contains (i) the ceramics for adjusting the dielectric constant ∈1, and (ii) the conductive particles for adjusting the tan δ1. Therefore, the ceramics and the conductive particles are beforehand mixed with the resin to be subjected to the injection molding.

Examples of the resin used here include: polyethersulfone (PPS), liquid crystal polymer (LCP), syndiotactic polystyrene (SPS), polycarbonate (PC), polyethylene terephthalate (PET), epoxy resin (EP), polyimide resin (PI), polyetherimide resin (PEI), phenol resin (PF), and the like. A specific example of the ceramics is barium titanate or the like. Examples of the conductive particles include: metal particles, carbon black particles, magnetic material particles, conductive polymer particles, and the like.

Thereafter, the electricity supply electrode 11 is formed in the inner surface of the dielectric member 13 thus formed. The electricity supply electrode 11 can be formed by carrying out plating with respect to the inner surface of the dielectric member 13. Alternatively, the electricity supply electrode 11 may be formed by deposition, sputtering deposition, application of a conductive paste to the inner surface, adhering of a metal plate thereto, embedding of a circular cone shaped metal thereto, and the like. Examples of the material of which the electricity supply electrode 11 include gold, silver, copper, and the like.

Thereafter, the earth electrode 12 and the electricity supply terminal 14 each processed to have a predetermined shape are installed. The earth electrode 12 is adhered to the rear surface of the dielectric member 13 by an adhesive agent or the like. The electricity supply terminal 14 is so adhered by a silver paste or the like as to be electrically connected to the electricity supply electrode 11.

As described above, the mono-conical antenna (dielectric-loaded antenna) 10 of the present embodiment includes: (a) the electricity supply electrode 11 (first electrode), which has the conical surface (facing the dielectric member 13); (b) the earth electrode 12 (second electrode), which has the flat surface that is so positioned as to face the apex of the conical surface (and that faces the dielectric member 13); and (c) the dielectric member 13, which is provided between the conical surface and the flat surface. Further, the mono-conical antenna (dielectric-loaded antenna) 20 of the present embodiment includes: (a) the electricity supply electrode 11 (first electrode), which has the conical surface (facing the dielectric member 23); (b) the earth electrode 12 (second electrode), which has the flat surface that is so positioned as to face the apex of the conical surface (and that faces the dielectric member 23); and (c) the dielectric member 23, which is provided between the conical surface and the flat surface.

In each of the mono-conical antennas 10 and 20, the apex V of the electricity supply electrode 11, and the vicinity of the through hole 12a of the earth electrode 12, i.e., each center portion of the electricity supply electrode 11 and the earth electrode 12 serves as the electricity supply portion. This makes it possible for each of the mono-conical antennas 10 and 20 to be an antenna handling the wide frequency band. Further, each of the dielectric members 13 and 23 allows the wavelength shortening effect. This makes it possible that each of the mono-conical antennas 10 and 20 becomes smaller.

Each of the mono-conical antennas 10 and 20 has the following structural features.

Firstly, the outer circumferential surface 13a of the dielectric member 13, and the outer circumferential surface 23a of the dielectric member 23 each have such a slope that extends from the conical surface to the flat surface. This makes it possible that the maximum value of the VSWR in a wider frequency band becomes smaller as compared with that in the case where the outer circumferential surface of the dielectric member forms a cylindrical shape (see FIG. 11 through FIG. 13).

Secondly, each of the dielectric members 13 and 23 includes (i) the dielectric member material such as a resin, and (ii) conductive particles mixed with the dielectric member material such that the loss coefficient of each of the dielectric members 13 and 23 is increased. This makes it possible to render predetermined loss coefficient to each of the dielectric members 13 and 23. The loss coefficient of each of the dielectric members 13 and 23 becomes high to some extent in this way, with the result that the waveform of the electromagnetic wave propagating inside each of the dielectric members 13 and 23 is attenuated. With this, the VSWR becomes smaller.

Note that each of the dielectric members 13 and 23 is not limited to the above structure containing the dielectric member material and the conductive particles, as long as the loss coefficient is 0.24 or greater. The dielectric members 13 and 23 each having a loss coefficient of 0.24 or greater allows the effect of attenuating the waveform of the electromagnetic wave propagating inside each of the dielectric members 13 and 23, with the result that the VSWR is lowered effectively. This makes it possible that the VSWR becomes smaller.

Such structural features allow (i) the downsizing of the mono-conical antenna, and (ii) handling of the wider frequency band in which the maximum value of the VSWR is restrained to be small. Note that combination of the structural features attains a more noticeable effect, but the structural features allow the above effects, respectively.

The present embodiment has explained the mono-conical antennas 10 and 20; however, the present invention is not limited to this. The above description is true of a dielectric-loaded antenna which includes (i) a first electrode having a first electricity supply portion, (ii) a second electrode having a second electricity supply portion, and (iii) a dielectric member provided between the first electrode and the second electrode, and which has such a cross sectional surface that the distance between the first electrode and the second electrode becomes larger as the first electrode and the second electrode respectively extend further from the first electricity supply portion and the second electricity supply portion.

Each of FIG. 26(a) and FIG. 26(b) illustrates an example of the cross sectional surface of such a dielectric-loaded antenna. As shown in FIG. 26(a), a first electrode 51 including a first electricity supply portion 51a, and a second electrode 52 including a second electricity supply portion 52a are so provided as to face each other with a dielectric member 53 therebetween. Similarly, as shown in FIG. 26(b), a first electrode 61 including a first electricity supply portion 61a, and a second electrode 62 including a second electricity supply portion 62a are so provided as to face each other with a dielectric member 63 therebetween.

The first electricity supply portion 51a of the first electrode 51 and the second electricity supply portion 52a of the second electrode 52 are positioned in such portions that the distance between the first electrode 51 and the second electrode 52 is the smallest. In other words, the first electrode 51 and the second electrode 52 are so provided that the distance therebetween becomes larger as the first electrode 51 and the second electrode 52 respectively extend further from the first electricity supply portion 51a and the second electricity supply portion 52a. Also, the first electricity supply portion 61a of the first electrode 61 and the second electricity supply portion 62a of the second electrode 62 are positioned in such portions that the distance between the first electrode 61 and the second electrode 62 is the smallest. In other words, the first electrode 61 and the second electrode 62 are so provided that the distance therebetween becomes larger as the first electrode 61 and the second electrode 62 respectively extend further from the first electricity supply portion 61a and the second electricity supply portion 62a.

Examples of such a dielectric-loaded antenna 50 include a bi-conical antenna. The bi-conical antenna has such a shape that corresponds to the shape of a rotation body obtained by rotating the cross sectional surface of FIG. 26(a) with respect to the center line C.

The dielectric member 53 of such a dielectric-loaded antenna 50 contains (i) the dielectric member material such as a resin and (ii) the conductive particles for increasing the loss coefficient of the dielectric member 53. Also, the dielectric member 63 of such a dielectric-loaded antenna 60 contains (i) the dielectric member material such as a resin and (ii) the conductive particles for increasing the loss coefficient of the dielectric member 63. This allows the waveform attenuation effect, with the result that the VSWR becomes small.

Further, the dielectric-loaded antenna 50 is arranged such that the dielectric member 53 has a loss coefficient of 0.24 or greater, and the dielectric-loaded antenna 60 is arranged such that the dielectric member 63 has a loss coefficient of 0.24 or greater. This allows the waveform attenuation effect, with the result that the VSWR is lowered effectively. Accordingly, the VSWR becomes smaller.

Note that each of the dielectric-loaded antennas 50 and 60 corresponds to each of the mono-conical antennas 10 and 20. Specifically, each of the first electrodes 51 and 61 corresponds to the electricity supply electrode 11, and each of the second electrodes 52 and 62 correspond to the earth electrode 12. Each of the first electricity supply portions 51a and 61a corresponds to the apex V of the electricity supply electrode 11. Each of the second electricity supply portions 52a and 62a corresponds to the vicinity of the through hole 12a of the earth electrode 12. Each of the dielectric members 53 and 63 corresponds to each of the dielectric members 13 and 23.

### Embodiment 2

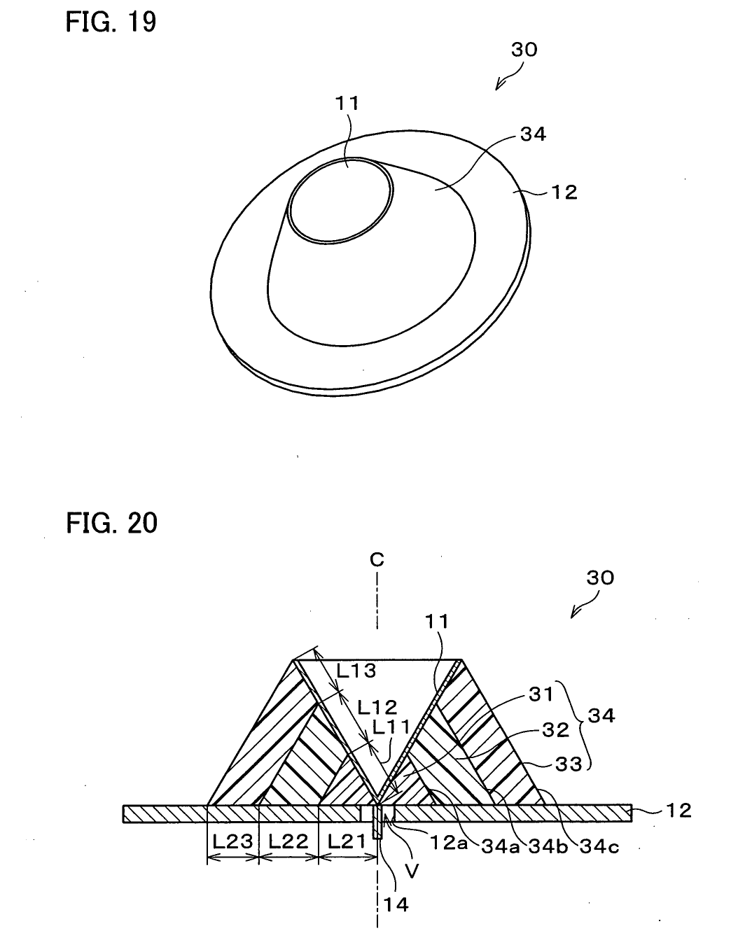

The following explains Embodiment 2 of the present invention with reference to FIG. 19 through FIG. 26. For ease of explanation, the same reference symbols will be given to materials that are provided in mono-conical antennas 30 and 40 to be explained in the present embodiment and that have the equivalent functions as those of the mono-conical antennas 10 and 20, and explanation thereof will be omitted here.

FIG. 19 is a perspective view illustrating the mono-conical antenna 30 of the present embodiment, and FIG. 20 is a cross sectional view illustrating the mono-conical antenna 30. The mono-conical antenna 30 includes the electricity supply electrode (first electrode) 11, the earth electrode (second electrode) 12, a dielectric member 34, and the electricity supply terminal 14. Here, the electricity supply electrode 11, the earth electrode 12, and the electricity supply terminal 14 are the same as those in Embodiment 1, respectively.

The dielectric member 34 has a shape identical to that of the dielectric member 13 described in Embodiment 1. Moreover, the electricity supply electrode 11, the earth electrode 12, and the electricity supply terminal 14 are provided in the same manner as those of the dielectric member 13 described in Embodiment 1. A difference between the dielectric members 13 and 34 lies in that the dielectric member 34 has a three-layer structure, i.e., is made up of three dielectric members whose electric properties are different from one another. Specifically, the dielectric member 34 is made up of (i) an innermost dielectric member 31, (ii) a dielectric member 32 covering the dielectric member 31, and (iii) an outermost dielectric member covering the dielectric member 32.

The dielectric member 34 has an outer circumferential surface 34c constituting a part of a conical surface, as is the case with that of the dielectric member 13. Further, the dielectric member 34 has a cross sectional surface taken along the flat surface encompassing the center line C, and the cross sectional surface is such a surface that: a boundary surface 34b between the dielectric member 33 and the dielectric member 32, and a boundary surface 34a between the dielectric member 32 and the dielectric member 31 are parallel to the outer circumferential surface 34c. Moreover, the dielectric member 34 has a shape corresponding to the shape of a rotation body obtained by rotating the cross sectional surface with respect to the center line C.

Each of the dielectric members 31, 32, and 33 has a side extending along the electricity supply electrode 11, i.e., a side extending in the direction of a generator of the electricity supply electrode 11. The side of the dielectric member 31 has a length L11, and the side of the dielectric member 32 has a length L12, and the side of the dielectric member 33 has a length L13. Moreover, each of the dielectric members 31, 32, and 33 has another side extending along the earth electrode 12, i.e., another side extending in the radial direction of the earth electrode 12. The side of the dielectric member 31 has a length L21, and the side of the dielectric member 32 has a length L22, and the side of the dielectric member 33 has a length L23. The length L11 is as long as the length L21, and the length L12 is as long as the length L22, and the length L13 is as long as the length L23.

Also in cases where the mono-conical antenna 30 is used to transmit and receive the electromagnetic wave, a cable such as a coaxial cable is connected to the center of the mono-conical antenna 30 via the earth electrode 12. Specifically, an inner conductor (core wire) of the coaxial cable is connected to the electricity supply terminal 14, and an outer conductor (shield) of the coaxial cable is connected to the earth electrode 12. For attainment of the connection, the earth electrode 12 is provided with a connector (not shown) by which the earth electrode 12 is connected to the coaxial cable. Note that the connector may not be provided and the coaxial cable may be connected directly to the earth electrode 12.

The dielectric member 31 of the dielectric member 34 has a dielectric constant ∈1a, and the dielectric member 32 of the dielectric member 34 has a dielectric constant ∈1b, and the dielectric member 33 of the dielectric member 34 has a dielectric constant ∈1c. The dielectric constants are so adjusted that specific inductive capacity of the dielectric member 31 is smaller than that of the dielectric member 32 and specific inductive capacity of the dielectric member 32 is smaller than that of the dielectric member 33. In other words, the dielectric member 34 has such a dielectric constant that comes closer to the dielectric constant ∈0 of the outer space in a staged manner, as the dielectric member 34 extends further toward the outer space.

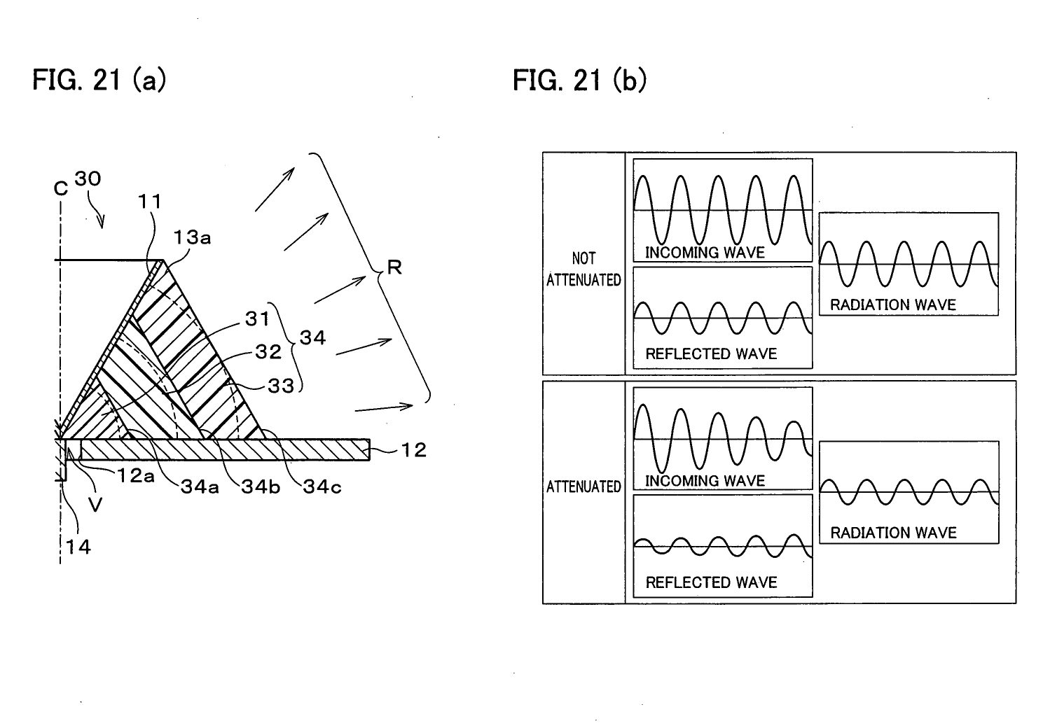

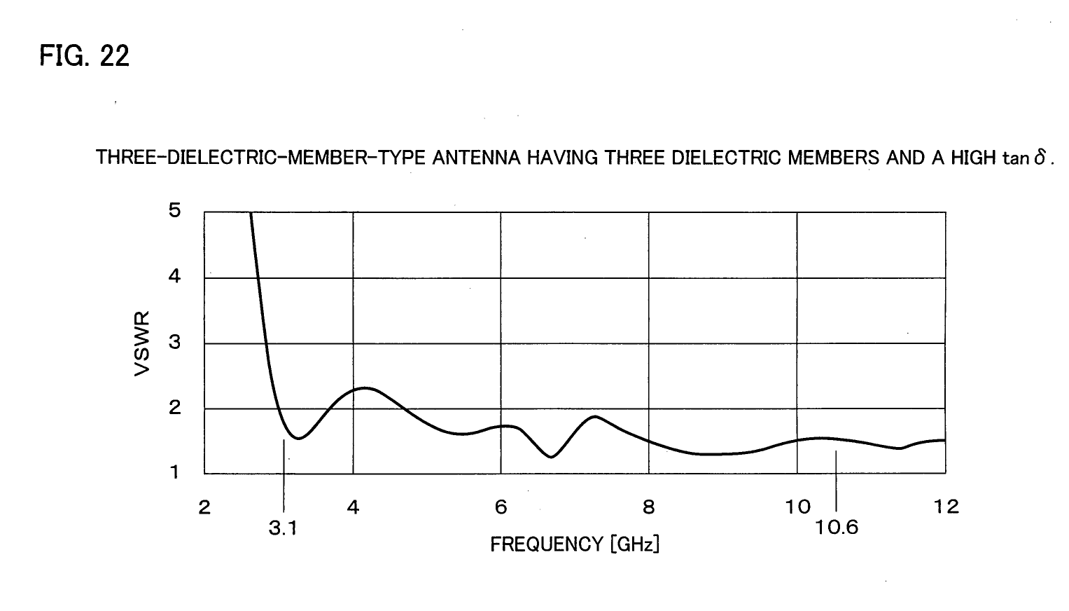

The following explains how the antenna property is influenced by setting the dielectric constant of the dielectric member 34 as described above, with reference to FIG. 21 and FIG. 22.

When transmitting the electromagnetic wave from the mono-conical antenna 30, an electric power is fed to the apex V of the electricity supply electrode 11 such that the high frequency electromagnetic wave is generated. The electromagnetic wave thus generated is diffused and propagated between the electricity supply electrode 11 and the earth electrode 12 as indicated by the broken line of FIG. 21(a). In other words, the high frequency wave is diffused and propagated inside the dielectric member 13, concentrically with respect to the apex V. The dielectric member 34 works to shorten the wavelength of the electromagnetic wave. Specifically, the wavelength of the electromagnetic wave is shortened according to respective dielectric constants ∈1a, ∈1b, and ∈1c of the dielectric members 31, 32, and 33. Accordingly, the wavelength of the electromagnetic wave inside the dielectric member 34 becomes shorter as compared with the wavelength of the electromagnetic wave outside the dielectric member 34.

As such, the mono-conical antenna 30 having the dielectric member 13 makes it possible to shorten the wavelength of the electromagnetic wave. Accordingly, the mono-conical antenna 30 can transmit an electromagnetic wave having longer wavelength, i.e., can transmit an electromagnetic wave having lower frequency as compared with that of an electromagnetic wave transmitted from an mono-conical antenna which has no dielectric member and which has the same size as that of the mono-conical antenna 30. Moreover, in cases where the mono-conical antenna 30 is so set as to have the same lower frequency limit as that of the mono-conical antenna having no dielectric member, the mono-conical antenna 30 has a size smaller than that of the mono-conical antenna having no dielectric member.

Specifically, a size required for attainment of the low frequency limit of 3.1 GHz in such a mono-conical antenna 30 is the same as the case of mono-conical antenna 10 of Embodiment 1. That is, the required size is that: e.g., the power electrode 11 has a maximum diameter (diameter of a portion corresponding to the bottom surface of the circular cone) of 12 mm, and the earth electrode 12 has a diameter of 34 mm, and the dielectric member 34 has a height (height in the direction of the center line C) of 16 mm, and each of L1 and L2 is 17 mm. Note that the dielectric members 31, 32, and 33 have specific inductive capacities of 12, 8, and 4, respectively. Note also that the tan δ1a of the dielectric member 31, the tan δ1b of the dielectric member 32, and tan δ1c of the dielectric member 33 are 0.1.

As described above, the electromagnetic wave is diffused and propagated inside the dielectric member 34, concentrically with respect to the apex V. The electromagnetic wave thus diffused and propagated is radiated, in the electromagnetic wave radiation direction R, from the outer circumferential surface 34c of the dielectric member 34 to the outer space. The electromagnetic wave radiation direction R substantially corresponds to the radial direction of a portion, positioned in the space between the electricity supply electrode 11 and the earth electrode 12, of the surface of the sphere concentric with the apex V.

Here, when the electromagnetic wave is radiated from the dielectric member 34 to the outer space after being propagated in the dielectric member, i.e., when the electromagnetic wave passes through the boundary surfaces 34a and 34b, and the outer circumferential surface 34c, the electromagnetic wave is reflected due to the difference in the dielectric constant. The following describes comparison between (i) the reflection occurring in the mono-conical antenna 10 of Embodiment 1 and (ii) the reflection occurring in the mono-conical antenna 30 of the present embodiment.

In the mono-conical antenna 10, the outer circumferential surface 13a is the only interface at which the dielectric constant is changed and which is positioned between the electricity supply portion and the outer space. On the other hand, in the mono-conical antenna 30, the outer circumferential surface 34c and the boundary surfaces 34a and 34b are the interfaces at which the dielectric constant is changed and which are positioned therebetween. In other words, the mono-conical antenna 30 has a larger number of interfaces reflecting the electromagnetic wave, as compared with the mono-conical antenna 10.

Assume that the dielectric constants ∈1 and ∈1a are equal to each other. In the mono-conical antenna 10, the change from the dielectric constant ∈1 to the dielectric constant ∈0 is relatively large at the boundary surface 34a. On the contrary, in the mono-conical antenna 30, the dielectric constant is changed to be smaller little by little in the following manner: the dielectric constant ∈1a is changed to the dielectric constant ∈1b at outer circumferential surface 13a, and then the dielectric constant ∈1b is changed to the dielectric constant ∈1c at the boundary surface 34b, and then the dielectric constant ∈1c is changed to the dielectric constant ∈0 at the outer circumferential surface 34c.

Accordingly, a larger number of portions in which the reflection occurs are spread (distributed) in the mono-conical antenna 30, as compared with those in the mono-conical antenna 10. This allows reduction of the influence of the reflected wave over each of such portions.

FIG. 22 is a graph illustrating a result of simulating, in the frequency band ranging from 3.1 GHz to 10.6 GHz, a change of the VSWR of the mono-conical antenna 30 having such a feature. Compare (i) the graph of FIG. 22 concerning the mono-conical antenna 30, with (ii) the graph of FIG. 9 concerning the mono-conical antenna 10. The comparison clarifies that the peak coming in the vicinity of a frequency of 4 GHz is especially smaller in the mono-conical antenna 30 than that in the mono-conical antenna 10. A presumable reason of this is as follows. That is, in the mono-conical antenna 10, strong reflected waves are generated intensively in the vicinity of the frequency of 4 GHz. However, the portions in which the reflection occurs are spread (distributed) in the mono-conical antenna 30, so that the reflected waves are also distributed in the vicinity of frequency of 4 GHz.

The degree of the change from the dielectric constant ∈1 to the dielectric constant ∈0 can be smaller at the outer circumferential surface 13a by reducing the dielectric constant ∈1 of the dielectric member 13 of the mono-conical antenna 10. However, the reduction of the dielectric constant ∈1 causes a great difference in the dielectric constant between the dielectric member 13 and each conductor of the electricity supply electrode 11 and the earth electrode 12, each of which is provided in the vicinity of the electricity supply portion. Accordingly, the reflection occurs intensively in the vicinity of the electricity supply portion. This is not preferable. Preferable is, e.g., the case of the mono-conical antenna 30: the dielectric constant is changed in such a staged manner that the dielectric constant of the dielectric member 31 is larger than the dielectric constant of the dielectric member 32, and that the dielectric constant of the dielectric member 32 is larger than the dielectric constant of the dielectric member 33, and that the dielectric constant of the dielectric member 33 is larger than the dielectric constant of the outer space.

Further, in the view of attaining a wide band, it is preferable that each dielectric dissipation factor tan δ be high to some extent also in the mono-conical antenna 30. The respective dielectric dissipation factors tan δ1a, tan δ1b, and tan δ1c of the dielectric members 31, 32, and 33 may be different from one another.

As is the case with Embodiment 1, the respective dielectric constants ∈1a, ∈1b, and ∈1c of the dielectric members 31, 32, and 33 can be adjusted by adjusting types and amounts of ceramics to be mixed in a resin of which each of the dielectric members 31, 32, and 33 are made. Moreover, the respective dielectric dissipation factors tan δ1a, tan δ1b, and tan δ1c of the dielectric members 31, 32, and 33 can be adjusted by adjusting types and amounts of conductive particles to be mixed in the resin.

Note that the dielectric member 34 explained here has the three-layer structure; however, the dielectric member 34 may have a two-layer structure, or a four-or-greater-layer structure. Note also that the dielectric constant of the dielectric member 34 explained here is changed in the staged manner; however, the dielectric constant thereof may be changed continuously (in a continuous manner).

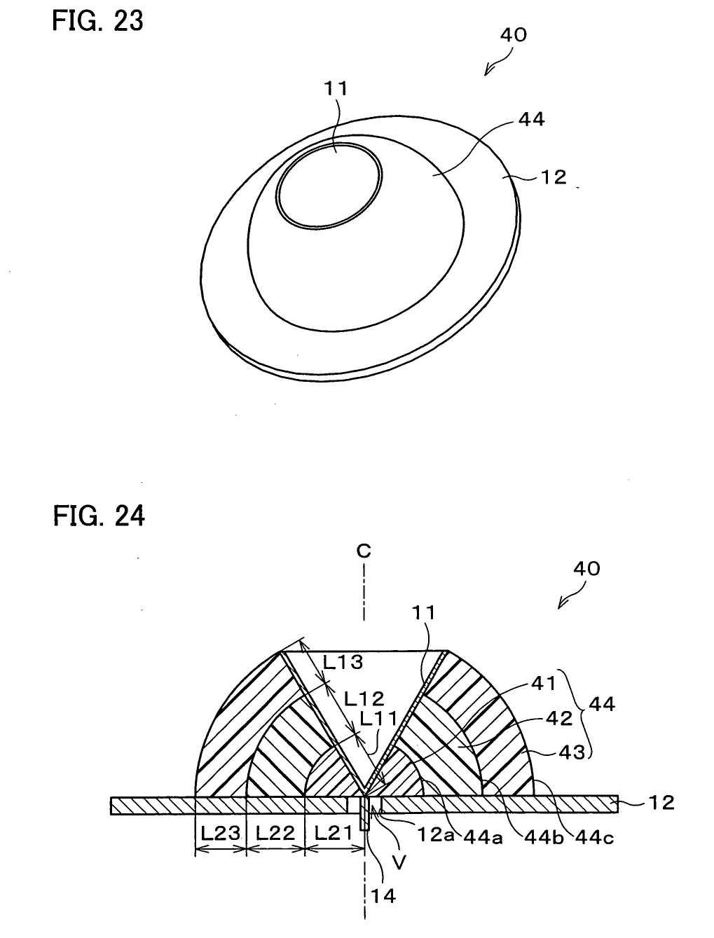

The following explains a mono-conical antenna 40 with reference to FIG. 23 and FIG. 24. The mono-conical antenna 40 is a modified example of the mono-conical antenna 30.

Also in cases where the dielectric member has such a multi-layer structure, it is preferable to form the dielectric member such that each of the boundary surfaces and the outer circumferential surface is in the form similar to the surface of a sphere whose center is the electricity supply portion. In light of this, the mono-conical antenna 40 is arranged such that boundary surfaces 44a and 44b, and an outer circumferential surface 44c of the dielectric member 44 are respectively in the form of the surfaces of spheres whose centers are the electricity supply portion. Apart from this, the structure of the mono-conical antenna 40 is the same as that of the mono-conical antenna 30.

Although the mono-conical antenna 30 allows sufficient lowering of the maximum value of the VSWR in the frequency band ranging from 3.1 GHz to 10.6 GHz, the mono-conical antenna 40 allows further lowering thereof. However, it is easier to form the boundary surfaces and the outer circumferential surface of the mono-conical antenna 30 as compared with the boundary surfaces 44a and 44b, and the outer circumferential surface 44c of the mono-conical antenna 40. Therefore, in consideration of (i) the lowering effect of the VSWR and (ii) easiness in manufacturing, a mono-conical antenna to be employed can be selected arbitrarily from the mono-conical antennas 30 and 40.

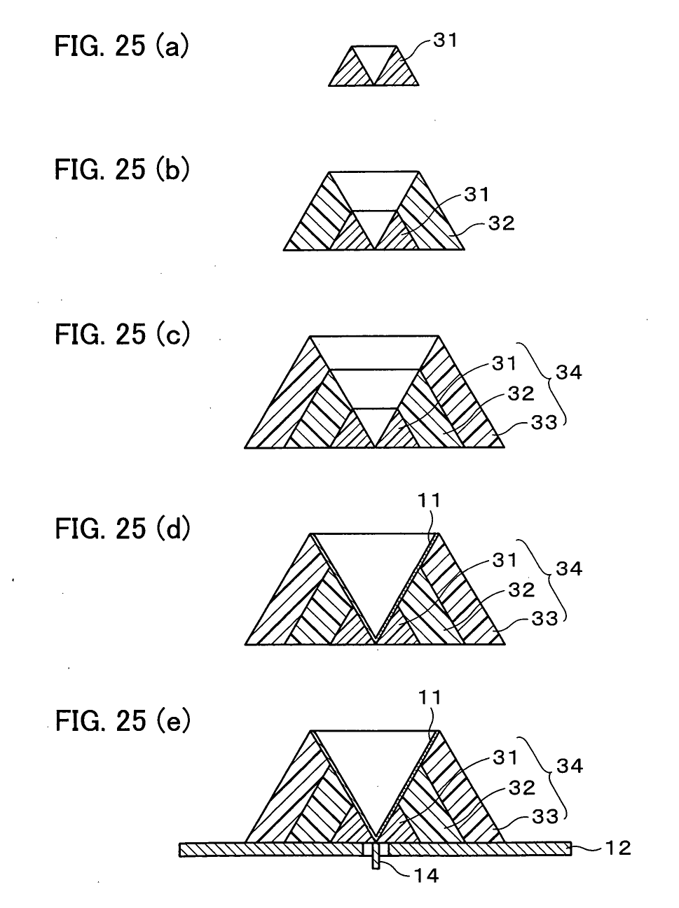

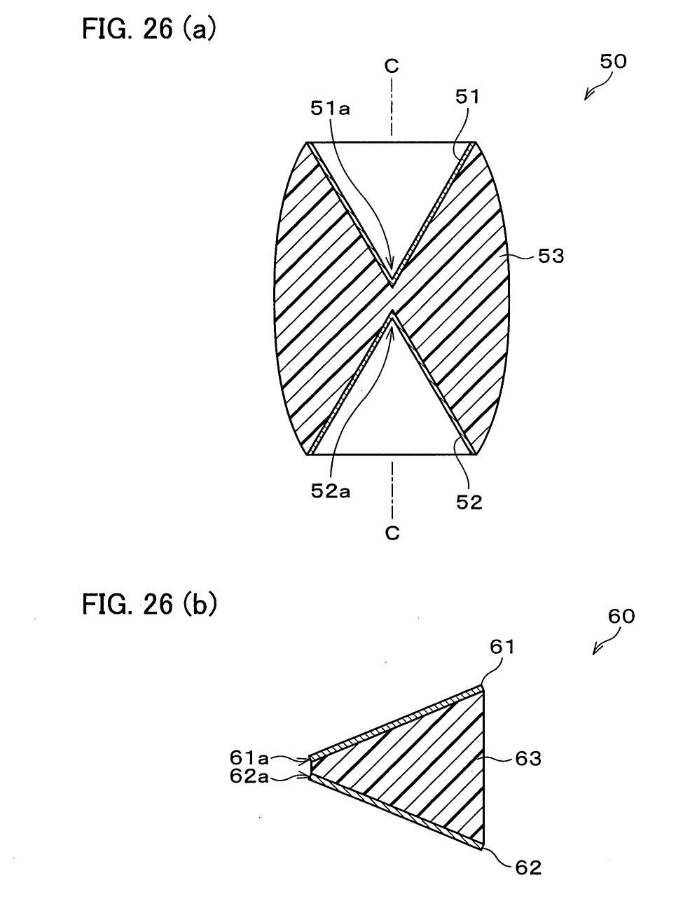

Explained next is one example of a method for manufacturing the mono-conical antennas 30, with reference to FIG. 25(a) and FIG. 25(e). Note that the mono-conical antenna 40 can be manufactured in accordance with substantially the same method, so that the following explanation assumes the method for manufacturing the mono-conical antenna 30.

Firstly carried out is formation of the dielectric member 31 as shown in FIG. 25(a). The dielectric member 31 can be formed by carrying out injection molding with respect to a resin with the use of a metal pattern.

Next, see FIG. 25(b). The dielectric member 32 is so formed as to cover the outer side of the dielectric member 31. The dielectric member 32 can be formed also by carrying out injection molding with respect to a resin with the use of a metal pattern. The injection molding for forming the dielectric member 32 is a multiple molding, and is carried out in such a manner that the dielectric member 31 is set in the center of the metal pattern. This makes it possible to attain simultaneously (i) the formation of the dielectric member 32, and (ii) the connecting of the dielectric members 32 and 31.

Next, see FIG. 25(c). The dielectric member 33 is so formed as to cover the outer side of the dielectric member 32. The dielectric member 33 can be formed also by carrying out injection molding with respect to a resin with the use of a metal pattern. The injection molding for forming the dielectric member 33 is a multiple molding, and is carried out in such a manner that the dielectric members 31 and 32 formed in one piece is set in the center of the metal pattern. This makes it possible to attain simultaneously (i) the formation of the dielectric member 32, and (ii) the connection between the dielectric members 32 and 31.

As described above, the dielectric members 31, 32, and 33 respectively contain (i) the ceramics for adjusting the dielectric constants ∈1a, ∈1b, and ∈1c; and (ii) the conductive particles for adjusting the tan δ1a, the tan δ1b, and the tan δ1c. Therefore, the ceramics and the conductive particles are beforehand mixed with the resin to be subjected to the injection molding.

The materials exemplified in Embodiment 1 can be used for the resin, the ceramics, and the conductive particles.

Next, see FIG. 25(d). The electricity supply electrode 11 is formed on the inner surface of the dielectric member 34 thus formed. The electricity supply electrode 11 can be formed by using the method and the material, each of which is described in Embodiment 1.

Thereafter, the earth electrode 12 and the electricity supply terminal 14 each processed to have a predetermined shape are installed. Specifically, the earth electrode 12 is adhered to the rear surface of the dielectric member 13 by an adhesive agent or the like. The electricity supply terminal 14 is so adhered by a silver paste or the like as to be electrically connected to the electricity supply electrode 11.

As described above, the mono-conical antenna 30 (dielectric-loaded antenna) of the present embodiment includes: (a) the electricity supply electrode 11 (first electrode), which has the conical surface (facing the dielectric member 34); (b) the earth electrode 12 (second electrode), which has the flat surface that is so positioned as to face the apex of the conical surface (and that faces the dielectric member 34); and (c) the dielectric member 34, which is provided between the conical surface and the flat surface. Further, the mono-conical antenna 40 (dielectric-loaded antenna) of the present embodiment includes: (a) the electricity supply electrode 11 (first electrode), which has the conical surface (facing the dielectric member 44); (b) the earth electrode 12 (second electrode), which has the flat surface that is so positioned as to face the apex of the conical surface (and that faces the dielectric member 44); and (c) the dielectric member 44, which is provided between the conical surface and the flat surface.

In each of the mono-conical antennas 30 and 40, the apex V of the electricity supply electrode 11, and the vicinity of the through hole 12a of the earth electrode 12, i.e., each center portion of the electricity supply electrode 11 and the earth electrode 12 serves as the electricity supply portion. This makes it possible for each of the mono-conical antennas 30 and 40 to be an antenna handling the wide frequency band. Further, each of the dielectric members 34 and 44 allows the wavelength shortening effect. This makes it possible that each of the mono-conical antennas 30 and 40 becomes smaller.

Each of the mono-conical antennas 30 and 40 has the following structural feature. That is, each of the dielectric members 34 and 44 has the portion whose specific inductive capacity becomes smaller in either the continuous manner or the staged manner as the dielectric member extends further from the apex V of the electricity supply electrode 11, i.e., from the side close to the electricity supply portion. With this, the electromagnetic wave propagating from the electricity supply portion is reflected, by portions positioned inside each of the dielectric members 34 and 44, according to the change of the specific inductive capacity.

Specifically, the portions reflecting the electromagnetic wave are distributed inside the dielectric member of each of the mono-conical antennas 30 and 40. Accordingly, reflected waves having different frequencies are distributed. This makes it possible to avoid such a problem that the VSWR in a certain frequency is caused to be large in response to intensive generation of strong reflected waves having the frequency. As the result, the maximum value of the VSWR in the wider frequency band can be lowered.

As such, each of the mono-conical antennas 30 and 40 has such a small size, and handles such a wider frequency band in which the maximum value of the VSWR is restrained to be small.

Note that the present embodiment has explained the mono-conical antennas 30 and 40; however, the above explanation is also true of the dielectric-loaded antennas 50 and 60 respectively having the cross sectional surfaces explained in Embodiment 1 with reference to FIG. 26(a) and FIG. 26(b).

That is, the dielectric members 53 is so arranged as to have the portion whose specific inductive capacity becomes smaller in either the continuous manner or the staged manner as the dielectric member 53 extends further from each of the first electricity supply portion 51a and the second electricity supply portion 52a. Similarly, the dielectric members 63 is so arranged as to have the portion whose specific inductive capacity becomes smaller in either the continuous manner or the staged manner as the dielectric member 63 extends further from each of the first electricity supply portion 61a and the second electricity supply portion 62a. This makes it possible to avoid such a problem that the VSWR in a certain frequency is caused to be large in response to intensive generation of strong reflected waves having the frequency.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

As described above, a dielectric-loaded antenna of the present invention includes: (i) a first electrode, which has a conical surface; (ii) a second electrode, which has a flat surface that is so positioned as to face an apex of the conical surface; and (iii) a dielectric member, which is provided between the conical surface and the flat surface, the dielectric member having an outer circumferential surface which has such a slope that extends from a side of the conical surface to a side of the flat surface.

This allows the dielectric-loaded antenna to have a small size, and to handle a wider frequency band in which the maximum value of the VSWR is restrained to be small.

The dielectric-loaded antenna of the present invention may be arranged such that: the outer circumferential surface of the dielectric member, a boundary surface between the dielectric member and the conical surface, and a boundary surface between the dielectric member and the flat surface respectively form rotation surfaces whose rotation axes are identical; and the dielectric member has such a cross sectional surface that is taken along a flat surface including the rotation axis, and that has a sector form in which the outer circumferential surface forms an arc and in which each of two sides respectively constituting (i) the boundary surface with the conical surface and (ii) the boundary surface with the flat surface serves as a radius.

Accordingly, the electromagnetic wave is secured from being reflected complicatedly inside the dielectric member, with the result that the VSWR is restrained from being extremely large.

Alternatively, the dielectric-loaded antenna of the present invention may be arranged such that: the outer circumferential surface of the dielectric member, a boundary surface between the dielectric member and the conical surface, and a boundary surface between the conical surface and the flat surface respectively form rotation surfaces whose rotation axes are identical; and the dielectric member has such a cross sectional surface that is taken along a flat surface including the rotation axis, and that has a shape of an isosceles triangle having two sides which have identical lengths and which respectively constitute (i) the boundary surface with the conical surface, and (ii) the boundary surface with the flat surface.

This makes it possible to restrain the complicated reflection from occurring inside the dielectric member, so that the VSWR is secured from being extremely large. Moreover, this makes it easier to form the dielectric member.

It is preferable to arrange the dielectric-loaded antenna of the present invention such that: the dielectric member contains (i) a dielectric member material, and (ii) a conductive particle that is mixed so as to increase a loss coefficient of the dielectric member.

This allows attenuation of the waveform of the electromagnetic wave propagating inside the dielectric member, with the result that the maximum value of the VSWR is lowered.

It is preferable to arrange the dielectric-loaded antenna of the present invention such that: the dielectric member has a loss efficient of 0.24 or greater.

This also allows attenuation of the waveform of the electromagnetic wave propagating inside the dielectric member, with the result that the maximum value of the VSWR is lowered.

A dielectric-loaded antenna of the present invention includes: (a) a first electrode, which has a conical surface; (b) a second electrode, which has a flat surface that is so positioned as to face an apex of the conical surface; and (c) a dielectric member, which is provided between the conical surface and the flat surface, the dielectric member containing (i) a dielectric member material, and (ii) a conductive particle that is mixed so as to increase a loss coefficient of the dielectric member.

This allows the dielectric-loaded antenna to have a small size, and to handle a wider frequency band in which the maximum value of the VSWR is restrained to be small.

A dielectric-loaded antenna of the present invention includes: (i) a first electrode, which has a conical surface; (ii) a second electrode, which has a flat surface that is so positioned as to face an apex of the conical surface; and (iii) a dielectric member, which is provided between the conical surface and the flat surface, the dielectric member having a loss efficient of 0.24 or greater.

This allows the dielectric-loaded antenna to have a small size, and to handle a wider frequency band in which the maximum value of the VSWR is restrained to be small.

A dielectric-loaded antenna of the present invention includes: (a) a first electrode, which has a conical surface; (b) a second electrode, which has a flat surface that is so positioned as to face an apex of the conical surface; and (c) a dielectric member, which is provided between the conical surface and the flat surface, the dielectric member having a portion whose specific inductive capacity is changed to be smaller in either a continuous manner or a staged manner as the dielectric member extends further from a side close to the apex of the conical surface.

This allows the dielectric-loaded antenna to have a small size, and to handle a wider frequency band in which the maximum value of the VSWR is restrained to be small.

Here, as compared with a case where the outer shape of the dielectric member has a cylindrical shape, the maximum value of the VSWR can be further lowered in cases where the dielectric-loaded antenna is arranged such that the outer circumferential surface of the dielectric member has such a slope that extends from the side of the conical surface to the flat surface.

Further, the dielectric member has a multi-layer structure, and can be formed with ease by providing, on top of each other, dielectric members having different specific inductive capacities.

The dielectric-loaded antenna of the present invention may be arranged such that: the dielectric member has a loss coefficient which changes in response to the change of the specific inductive capacity of the dielectric member.

A dielectric-loaded antenna of the present invention includes: (a) a first electrode, which has a first electricity supply portion; (b) a second electrode, which has a second electricity supply portion; and (c) a dielectric member, which is provided between the first electrode and the second electrode, the dielectric-loaded antenna having such a cross sectional surface that a distance becomes longer between the first electrode and the second electrode, as the first electrode and the second electrode respectively extend further from the first electricity supply portion and the second electricity supply portion, the dielectric member containing (i) a dielectric member material, and (ii) a conductive particle that is mixed so as to increase a loss coefficient of the dielectric member.

This allows the dielectric-loaded antenna to have a small size, and to handle a wider frequency band in which the maximum value of the VSWR is restrained to be small.

A dielectric-loaded antenna of the present invention includes: (a) a first electrode, which has a first electricity supply portion; (b) a second electrode, which has a second electricity supply portion; and (c) a dielectric member, which is provided between the first electrode and the second electrode, the dielectric-loaded antenna having such a cross sectional surface that a distance becomes longer between the first electrode and the second electrode as the first electrode and the second electrode respectively extend further from the first electricity supply portion and the second electricity supply portion, the dielectric member having a loss coefficient of 0.24 or greater.

This allows the dielectric-loaded antenna to have a small size, and to handle a wider frequency band in which the maximum value of the VSWR is restrained to be small.

A dielectric-loaded antenna of the present invention includes: (a) a first electrode, which has a first electricity supply portion; (b) a second electrode, which has a second electricity supply portion; and (c) a dielectric member, which is provided between the first electrode and the second electrode, the dielectric-loaded antenna having such a cross sectional surface that a distance becomes longer between the first electrode and the second electrode as the first electrode and the second electrode respectively extend further from the first electricity supply portion and the second electricity supply portion, the dielectric member having such a specific inductive capacity that is changed to be smaller in either a continuous manner or a staged manner as the dielectric member further extends from each of the first electrode and the second electrode in the cross sectional antenna.

This allows the dielectric-loaded antenna to have a small size, and to handle a wider frequency band in which the maximum value of the VSWR is restrained to be small.

The dielectric-loaded antenna having any one of the aforementioned cross sectional surface may be so arranged as to form a rotation body obtained by rotating the cross sectional surface with respect to a rotation axis meeting each of the electricity supply portions.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention can be used, e.g., as an antenna used in a mobile information processing apparatus having a wireless communication function.

1. A dielectric-loaded antenna, comprising:
a first electrode, which has a conical surface;
a second electrode, which has a flat surface that is so positioned as to face an apex of the conical surface; and
a dielectric member, which is provided between the conical surface and the flat surface, the dielectric member having an outer circumferential surface which has such a slope that extends from a side of the conical surface to a side of the flat surface.

2. The dielectric-loaded antenna as set forth in claim 1, wherein:
the outer circumferential surface of the dielectric member, a boundary surface between the dielectric member and the conical surface, and a boundary surface between the dielectric member and the flat surface respectively form rotation surfaces whose rotation axes are identical; and
the dielectric member has such a cross sectional surface that is taken along a flat surface including the rotation axis, and that has a sector form in which the outer circumferential surface forms an arc and in which each of two sides respectively constituting (i) the boundary surface with the conical surface and (ii) the boundary surface with the flat surface serves as a radius.

3. The dielectric-loaded antenna as set forth in claim 1, wherein:
the outer circumferential surface of the dielectric member, a boundary surface between the dielectric member and the conical surface, and a boundary surface between the dielectric member and the flat surface respectively form rotation surfaces whose rotation axes are identical; and
the dielectric member has such a cross sectional surface that is taken along a flat surface including the rotation axis, and that has a shape of an isosceles triangle having two sides which have identical lengths and which respectively constitute (i) the boundary surface with the conical surface, and (ii) the boundary surface with the flat surface.

4. The dielectric-loaded antenna as set forth in claim 1, wherein:
the dielectric member contains (i) a dielectric member material, and (ii) a conductive particle that is mixed so as to increase a loss coefficient of the dielectric member.

5. The dielectric-loaded antenna as set forth in claim 1, wherein:
the dielectric member has a loss efficient of 0.24 or greater.

6. A dielectric-loaded antenna, comprising:
a first electrode, which has a conical surface;
a second electrode, which has a flat surface that is so positioned as to face an apex of the conical surface; and
a dielectric member, which is provided between the conical surface and the flat surface, the dielectric member containing (i) a dielectric member material, and (ii) a conductive particle that is mixed so as to increase a loss coefficient of the dielectric member.

7. A dielectric-loaded antenna, comprising:
a first electrode, which has a conical surface;
a second electrode, which has a flat surface that is so positioned as to face an apex of the conical surface; and
a dielectric member, which is provided between the conical surface and the flat surface, the dielectric member having a loss efficient of 0.24 or greater.

8. A dielectric-loaded antenna, comprising:
a first electrode, which has a conical surface;
a second electrode, which has a flat surface that is so positioned as to face an apex of the conical surface; and
a dielectric member, which is provided between the conical surface and the flat surface, the dielectric member having a portion whose specific inductive capacity is changed to be smaller in either a continuous manner or a staged manner as the dielectric member extends further from a side close to the apex of the conical surface.

9. The dielectric-loaded antenna as set forth in claim 8, wherein:
the dielectric member has an outer circumferential surface which has such a slope that extends from a side of the conical surface to a side of the flat surface.

10. The dielectric-loaded antenna as set forth in claim 8, wherein:
the dielectric member has such a multi-layer structure that dielectric members having different specific inductive capacities are provided on top of each other.

11. The dielectric-loaded antenna as set forth in claim 8, wherein:
the dielectric member has a loss coefficient which changes in response to the change of the specific inductive capacity of the dielectric member.

12. A dielectric-loaded antenna, comprising:
a first electrode, which has a first electricity supply portion;
a second electrode, which has a second electricity supply portion; and
a dielectric member, which is provided between the first electrode and the second electrode,
said dielectric-loaded antenna having such a cross sectional surface that a distance becomes longer between the first electrode and the second electrode, as the first electrode and the second electrode respectively extend further from the first electricity supply portion and the second electricity supply portion, the dielectric member containing (i) a dielectric member material, and (ii) a conductive particle that is mixed so as to increase a loss coefficient of the dielectric member.

13. A dielectric-loaded antenna, comprising:
a first electrode, which has a first electricity supply portion;
a second electrode, which has a second electricity supply portion; and
a dielectric member, which is provided between the first electrode and the second electrode,
said dielectric-loaded antenna having such a cross sectional surface that a distance becomes longer between the first electrode and the second electrode as the first electrode and the second electrode respectively extend further from the first electricity supply portion and the second electricity supply portion,
the dielectric member having a loss coefficient of 0.24 or greater.

14. A dielectric-loaded antenna, comprising:
a first electrode, which has a first electricity supply portion;
a second electrode, which has a second electricity supply portion; and
a dielectric member, which is provided between the first electrode and the second electrode,
said dielectric-loaded antenna having such a cross sectional surface that a distance becomes longer between the first electrode and the second electrode as the first electrode and the second electrode respectively extend further from the first electricity supply portion and the second electricity supply portion,
the dielectric member having such a specific inductive capacity that is changed to be smaller in either a continuous manner or a staged manner as the dielectric member further extends from each of the first electrode and the second electrode in the cross section.

15. The dielectric-loaded antenna as set forth in claim 12:
said dielectric-loaded antenna forming a rotation body obtained by rotating the cross sectional surface with respect to a rotation axis meeting each of the electricity supply portions.

16. The dielectric-loaded antenna as set forth in claim 13:
said dielectric-loaded antenna forming a rotation body obtained by rotating the cross sectional surface with respect to a rotation axis meeting each of the electricity supply portions.

17. The dielectric-loaded antenna as set forth in claim 14:
said dielectric-loaded antenna forming a rotation body obtained by rotating the cross sectional surface with respect to a rotation axis meeting each of the electricity supply portions.
